(19) United States
(12) Patent Application Publication
(10) Pub. No.: US 2024/0381338 A1
(43) Pub. Date: Nov. 14, 2024

(54) METHOD FOR TRANSMITTING XR SERVICE, TERMINAL DEVICE, NETWORK DEVICE, AND STORAGE MEDIUM

(71) Applicant: GUANGDONG OPPO MOBILE TELECOMMUNICATIONS CORP., LTD., Dongguan (CN)

(72) Inventors: Zhe FU, Dongguan (CN); Qianxi LU, Dongguan (CN)

(73) Assignee: GUANGDONG OPPO MOBILE TELECOMMUNICATIONS CORP., LTD., Dongguan (CN)

(21) Appl. No.: 18/783,275

(22) Filed: Jul. 24, 2024

Related U.S. Application Data
(63) Continuation of application No. PCT/CN2022/074984, filed on Jan. 29, 2022.

(51) Int. Cl. H04W 72/12; H04W 76/18

(52) U.S. Cl. CPC H04W 72/12; H04W 76/18

(57) ABSTRACT

Embodiments of this application provide a method for transmitting an XR service, a terminal device, a network device, and a storage medium, to ensure system capacity with a service transmission requirement ensured. The method in this application may include: performing, based on at least one of configuration information, a CG resource, or a service feature by a terminal device, at least one of configuring of the CG resource, determining of use of the CG resource, data transmission by using the CG resource, or reporting.

### CROSS-REFERENCE TO RELATED APPLICATIONS

This application is a continuation of International Application No. PCT/CN2022/074984, filed on Jan. 29, 2022, the disclosure of which is hereby incorporated by reference in its entirety.

### TECHNICAL FIELD

This application relates to the field of communications, and in particular, to a method for transmitting an XR service, a terminal device, a network device, and a storage medium.

### BACKGROUND

According to R18 service requirements, for example, XR has requirements of relatively high reliability and low delay. In addition, for the XR service, a data packet size of the XR service is variable, namely, (variable XR data rate). However, a data packet size of services supported in an existing system is unchanged or basically unchanged. This is because it needs to consider how to support the R18 service requirements, and ensure system capacity with a service transmission requirement ensured.

### SUMMARY

Embodiments of this application provide a method for transmitting an XR service, a terminal device, a network device, and a storage medium.

In a first aspect, this application provides a method for transmitting an extended reality XR service, where the method may include: performing, based on at least one of configuration information, a CG resource, or a service feature by a terminal device, at least one of configuring of the CG resource, determining of use of the CG resource, data transmission by using the CG resource, or reporting.

In a second aspect, this application provides a method for transmitting an extended reality XR service, where the method may include: performing, by the network device based on a service feature, resource configuration or scheduling on a terminal device or a service to schedule a first resource, to obtain configuration information and/or a configured first resource, where the first resource includes a CG resource and/or an SPS resource.

In a third aspect, this application provides a method for transmitting an extended reality XR service, where the method may include:
scheduling, by a terminal device by using DCI according to a network device, retransmission corresponding to a plurality of first resources, where the first resource includes a CG resource and/or an SPS resource.

In a fourth aspect, this application provides a terminal device, where the terminal device may include:
a processing module, configured to perform, based on at least one of configuration information, a CG resource, or a service feature, at least one of configuring of the CG resource, determining of use of the CG resource, data transmission by using the CG resource, or reporting.

In a fifth aspect, this application provides a network device, which may include:
a processing module, configured to perform, based on a service feature, resource configuration or scheduling on a terminal device or a service to schedule a first resource, to obtain configuration information and/or a configured first resource, where the first resource includes a CG resource and/or an SPS resource.

In a sixth aspect, this application provides a terminal device, which may include:
a processing module, configured to schedule, by using DCI according to a network device, retransmission corresponding to a plurality of first resources, where the first resource includes a CG resource and/or an SPS resource.

In a seventh aspect, this application provides a terminal device, which may include:
a memory storing executable program codes; and
a processor that is coupled to the memory, and a transceiver.
The processor and the transceiver are configured to execute the method according to the first aspect of this application.

In an eighth aspect, this application provides a network device, which may include:
a memory storing executable program codes; and
a processor coupled to the memory.
The processor is configured to execute the method according to the second aspect of this application.

In a ninth aspect, this application provides a terminal device, which may include:
a memory storing executable program codes; and
a processor coupled to the memory.

The processor is configured to execute the method according to the third aspect of this application.

In another aspect, embodiments of this application provide a computer-readable storage medium, including instructions. When the instructions run on a computer, the computer is caused to perform the method according to the first aspect, the second aspect, or the third aspect of this application.

In another aspect, embodiments of this application provide a chip, where the chip is coupled to a memory in the terminal device, so that the chip invokes, when running, program instructions stored in the memory, to cause the terminal device to execute the method according to the first aspect, the second aspect, or the third aspect of this application.

In technical solutions provided in embodiments of this application, a terminal device performs, based on at least one of configuration information, a CG resource, or a service feature, at least one of configuring of the CG resource, determining of use of the CG resource, data transmission by using the CG resource, or reporting.

### BRIEF DESCRIPTION OF DRAWINGS

FIG. 1 is a system architectural diagram of a communications system to which embodiments of this application are applicable.

FIG. 2 is a schematic diagram of a method for transmitting an extended reality XR service according to an embodiment of this application.

FIG. 3 is a schematic diagram of a method for transmitting an extended reality XR service according to another embodiment of this application.

FIG. 4 is a schematic diagram of a method for transmitting an extended reality XR service according to another embodiment of this application.

FIG. 5 is a schematic diagram of a method for transmitting an extended reality XR service according to another embodiment of this application.

FIG. 6 is a schematic diagram of a method for transmitting an extended reality XR service according to another embodiment of this application.

FIG. 7 is a schematic diagram of a method for transmitting an extended reality XR service according to another embodiment of this application.

FIG. 8 is a schematic diagram of a terminal device according to an embodiment of this application.

FIG. 9 is a schematic diagram of a network device according to an embodiment of this application.

FIG. 10 is a schematic diagram of a terminal device according to another embodiment of this application.

FIG. 11 is a schematic diagram of a network device according to another embodiment of this application.

### DESCRIPTION OF EMBODIMENTS

The following describes the technical solutions in embodiments of this application with reference to the accompanying drawings in embodiments of this application. Apparently, the described embodiments are merely some rather than all of embodiments of this application. All other embodiments obtained by persons of ordinary skill in the art based on embodiments of this application without creative efforts fall within the protection scope of this application.

The following briefly describes related technologies in this application, and details are as follows.

### 1. Background Related to Extended Reality (XR)/Ultra-Reliable and Low Latency Communications (URLLC) in R18

In the future, 3rd generation partnership project (3GPP) systems will provide more and more extensive and in-depth support for vertical industries. For example, a URLLC requirement supports transmission of services such as factory automation, transmission automation, and intelligent power in a 5G system. An XR requirement supports transmission of service including an augmented reality (AR)/virtual reality (VR)/cloud gaming. Reliability and delay requirements are common for these services, because a quality of service (QOS) requirement of data transmission needs to be met when a resource is scheduled for a user equipment (UE). For the UE, the UE also needs to meet a requirement of power consumption, so as to avoid unnecessary power consumption. In addition, considering access of a large quantity of UEs that support the service, a network capacity requirement needs to be ensured during resource allocation.

Typically, for the URLLC and the XR, a service with requirements of a minimum 0.5 ms and 99.999% needs to be supported. The service may be in a pseudo-periodic manner (that is, an arrival time of the service has jitters, that is, the service does not arrive at a specified time, but arrives at any time in a range). In addition, a service periodicity may be a non-integer periodicity, such as 16.67 ms. Moreover, there may be a large difference in time for arrival of different service flows of a same service (for example, for AR, an UpLink pose (UL pose) periodicity is 4 ms, but a UL video periodicity is 16.67 ms).

For a service of augmented reality (AR)/virtual reality (VR)/cloud gaming, a possible service model is as follows:
VR: UL pose information+DownLink video stream (DL video stream);
Configured grant (CG): UL control information+DL video stream; and
AR: UL (pose information+UL video stream)+DL video stream.

A periodicity of the control information or pose information is approximately 4 ms, and a packet size requirement is approximately 100 bytes. A periodicity of the video stream is approximately 16.67 ms, and a packet size requirement is approximately 0.67 Mbps.

In addition, each service is a pseudo-periodic service, that is, each service arrives periodically. However, a time point at which a service arrives has jitters in each periodicity, that is, the service arrives in a time range.

In particular, for the AR, for UL, there are pose information and video information in one periodicity, and arrival times of the two types of streams are different from each other.

In particular, for an XR service, a data packet size is variable (ii).

Features of the XR service are as follows:
an XR traffic periodicity is non-integer (the non-integer XR traffic periodicity);
an XR data packet size is variable (variable XR data rate); and
an XR periodicity is quasi-periodic, hence enhancements would be beneficial in this area (quasi-periodic XR periodicity, hence enhancements would be beneficial in this area).

### 2. CG Enhancement in Existing URLLC-See TS 38.321

To support a requirement of high delay of a URLLC service, URLLC enhances a configured grant (CG) periodicity, and supports a service periodicity of any slot level.

To support a plurality of URLLC services and a high delay requirement of the URLLC services, URLLC introduces multiple CGs. Different CGs are configured with different hybrid automatic repeat request (HARQ) processes, and different processes for different CGs are ensured by using harq-ProcID-Offset2.

To activate a CG, a single CG activation mode is used. To deactivate a CG, single CG deactivation or combined CG deactivation is supported.

Since there is a case in which a CG resource conflicts with another resource, to ensure that a medium access control protocol data unit (MAC PDU) (that is, Deprioritized MAC PDU) that is already packaged in the CG resource is not discarded/transmitted as soon as possible, automatic transmission for a CG is introduced. For CGs that are of the packaged MAC PDU and that cannot be transmitted due to a resource conflict, a CG resource in a same subsequent HARQ process and in a same CG configuration may be used for new transmission. Automatic transmission is determined by using an automatic transmission antenna (autonomousTx).

If priorities at the physical layer are different, that is, there is a conflict between CGs, MAC may transmit one or more MAC PDUs to the physical layer. Similarly, if there is a conflict between data and scheduling request (SR), the MAC may also transmit an SR and a MAC PDU to the physical layer.

A configured grant retransmission timer (CGRT) is stopped when a low-priority resource appears ((configuring logical channel based prioritization (LCH-based prioritization) and autonomousTx)).

According to R18 service requirements, for example, XR has requirements of relatively high reliability and low delay. In addition, for the XR service, a data packet size of the XR service is variable, namely, (variable XR data rate). However, a data packet size of services supported in an existing system is unchanged or basically unchanged. This is because it needs to consider how to support the R18 service requirements, and ensure system capacity with a service transmission requirement ensured.

Embodiments of this application are described with reference to a network device and a terminal device. The terminal device may also be referred to as a user equipment (UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN), or the like.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, or the like.

By way of example rather than limitation, in embodiments of this application, the terminal device may alternatively be a wearable device. The wearable device may also be referred to as a smart wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, the wearable smart device includes a full-featured and large-sized device that can implement all or some functions without relying on a smartphone, for example, a smart watch or smart glasses, and a device that only focus on a specific type of application function and needs to be used in cooperation with another device such as a smartphone, for example, various smart bracelets and smart jewelries for physical sign monitoring.

In embodiments of this application, the network device may be a device configured to communicate with a mobile device. The network device may be an access point (AP) in a WLAN, a base transceiver station (BTS) in GSM or CDMA, a NodeB (NB) in WCDMA, an evolved Node B (eNB or eNodeB) in LTE, a relay station or an access point, a vehicle-mounted device, a wearable device, a network device (gNB) in an NR network, a network device in a future evolved PLMN network, a network device in an NTN network, or the like.

By way of example rather than limitation, in embodiments of this application, the network device may have a mobility characteristic. For example, the network device may be a mobile device. In at least one embodiment, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In at least one embodiment, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

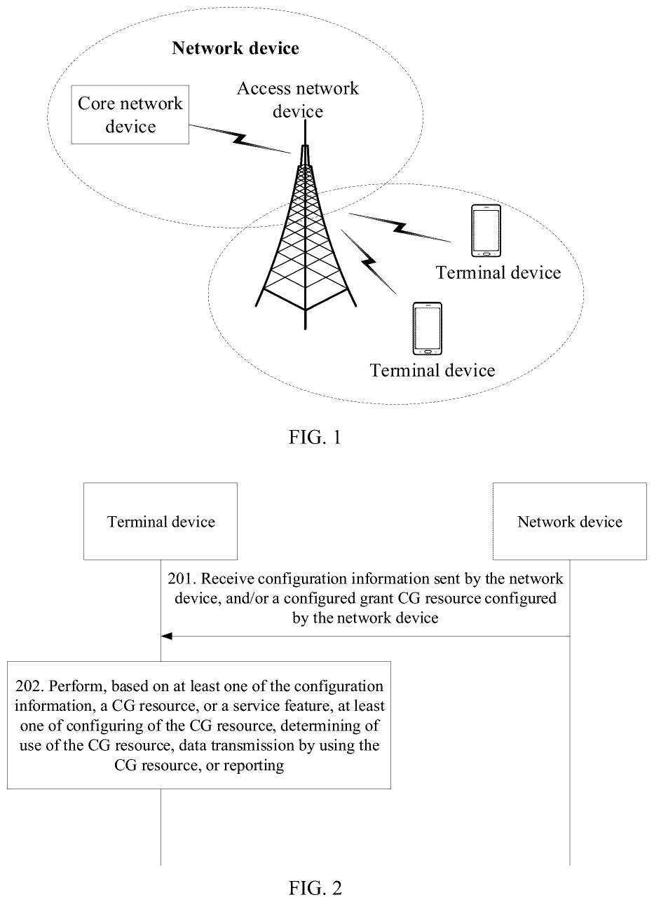

As shown in FIG. 1, FIG. 1 is a system architectural diagram of a communications system to which embodiments of this application are applicable. The communications system may include a network device, and the network device may be a device that communicates with a terminal device (or referred to as a communications terminal or a terminal). The network device may provide communication coverage for a specific geographic area, and may communicate with a terminal device located within the coverage. FIG. 1 exemplarily shows one network device and two terminal devices. In at least one embodiment, the communications system may include a plurality of network devices, and another quantity of terminal devices may be included in a coverage range of each network device, which is not limited in embodiments of this application. In at least one embodiment, the communications system may further include another network entity such as a network controller or a mobility management entity, which is not limited in embodiments of this application.

The network device may further include an access network device and a core network device. That is, the wireless communications system further includes a plurality of core networks configured to communicate with the access network device. The access network device may be an evolved Node B (which may be an eNB or an e-Node B for short), a macro base station, a micro base station (also referred to as a “small cell”), a pico base station, an access point (AP), a transmission point (TP), or a new generation Node B (gNodeB), or the like in a long-term evolution (LTE) system, a next generation (mobile communications system) (next radio, NR) system, or an authorized auxiliary access long-term evolution (LAA-LTE) system.

It should be understood that a device having a communication function in a network/system in embodiments of this application may be referred to as a communications device. The communications system shown in FIG. 1 is used as an example. The communications device may include a network device and a terminal device that have a communications function. The network device and the terminal device may be specific devices in embodiments of this application. Details are not described herein again. The communications device may further include another device in the communications system, such as a network controller and a mobility management entity, which is not limited in embodiments of this application.

As shown in FIG. 2, FIG. 2 is a schematic diagram of a method for transmitting an extended reality XR service according to an embodiment of this application, which may include the following steps.

201. A terminal device receives configuration information sent by a network device, and/or a configured grant CG resource configured by the network device.

In at least one embodiment, the configuration information includes at least one of the following:
a. a plurality of CG resources;
b. one CG resource;
c. a mapping relationship or an association relationship between a first logical channel LCH and the CG resource, or a logical channel mapping limitation;
d. that the CG resource is configured by using a radio resource control reconfiguration message (RRC re config) or through a CG configuration (CG config);
e. that the CG resource is used for activating/resuming, or used for deactivating/suspending;
f. that a type of the CG resource is CG Type1 and/or CG Type2;
g. a parameter corresponding to a first condition and a second condition, where the first condition and the second condition are used for activating/resuming or used for deactivating/suspending;
h. an enabling or activation indication corresponding to the first condition and the second condition;
i. an enabling or activation indication corresponding to a first case and a second case; or
j. an enabling or activation indication for the terminal device to perform, automatically or based on a condition, activating/resuming and/or deactivating/suspending on the CG resource.

(1) In at least one embodiment, in a case that the configuration information includes the plurality of CG resources, at least one of the following is included:
that each periodicity of at least one of the plurality of CG resources includes one or more CG resource locations;
that resource locations of the plurality of CG resource locations are consecutive in one time period;
that resource locations of the plurality of CG resource locations are not consecutive in one time period;
that different hybrid automatic repeat request HARQ processes are used for resource locations of the plurality of CG resource locations in one time period;
a binding relationship of the plurality of CG resources; or a default CG resource in the plurality of CG resources.

For example, one time period may refer to one or more CG periodicities. That resource locations are consecutive may be that resource locations are consecutive between slots or in a slot.

(2) In at least one embodiment, in a case that the configuration information includes the one CG resource, at least one of the following is included:
that each periodicity of the one CG resource includes one or more CG resource locations;
that resource locations of the plurality of CG resource locations are consecutive in one periodicity;
that resource locations of the plurality of CG resource locations are not consecutive in one periodicity;
that different hybrid automatic repeat request (HARQ) processes are used for resource locations of the plurality of CG resource locations in one periodicity;
a default CG resource location in the one CG resource; or
a default CG resource location in the plurality of CG resource locations.

For example, one periodicity may refer to one CG periodicity. That resource locations are consecutive may be that resource locations are consecutive between slots or in a slot.

(3) In at least one embodiment, the configuration information is in granularity of at least one of the following: a logical channel (LCH)/a data radio bearer (DRB)/a medium access control entity (MAC entity)/a packet data convergence protocol (PDCP)/a user equipment (UE)/a component carrier (CC)/a configured grant (CG).

For example, the foregoing g, h, i, and j may be for the LCH/the DRB/the MAC entity/the PDCP/the UE/the CC/the CG.

(4) In at least one embodiment, in a case that the configuration information includes the mapping relationship or the association relationship between a first LCH and the CG resource, or the logical channel mapping limitation, at least one of the following is included:
the first LCH corresponds to an XR service;
the CG resource is associated with the first LCH, or the first LCH is capable of being mapped to the CG resource;
the CG resource is associated with only the first LCH; or
the first LCH is associated with only the CG resource.

202. The terminal device performs, based on at least one of configuration information, a CG resource, or a service feature, at least one of configuring of the CG resource, determining of use of the CG resource, data transmission by using the CG resource, or reporting.

In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

(1) In at least one embodiment, the performing determining of use of the CG resource, or the performing data transmission by using the CG resource includes at least one of the following: performing activation, resuming, deactivation, or suspending on the CG resource automatically or based on a condition.

1) In at least one embodiment, the performing activation, resuming, deactivation, or suspending on the CG resource automatically or based on a condition may include: when data packet information meets a first condition, and/or according to a first enabling or activation indication of the network device, automatically performing activation or resuming on the CG resource, where the first condition includes at least one of the following:
the data packet information is greater than or equal to a first threshold;
a data packet arrives at a first time, for example, the first time may present periodically, or may present aperiodically; the first time may be indicated by a core network (CN) or an application layer; or the first time is a time different from a second time; or
a data packet is of a first specific type (for example, a full frame).

For example, when there is more data (data rate is greater than A), a UE activates/resumes a plurality of CG resources or a plurality of CG physical uplink shared channels (PUSCH) in one CG resource.

2) In at least one embodiment, the performing activation, resuming, deactivation, or suspending on the CG resource automatically or based on a condition may include: when data packet information meets a second condition, and/or according to a second enabling or activation indication of the network device, automatically performing activation or resuming on the CG resource.

The second condition includes at least one of the following:
the data packet information is less than a second threshold;
a data packet arrives at the second time, for example, the second time may present periodically, or may present aperiodically; the second time may be indicated by a CN or an application layer; or the second time is a time different from the first time; or
a data packet is of a second specific type, for example, a non-full frame or a delta frame of a full frame.

For example, when there is less data (data rate is less than B), a UE reactivates/suspends a plurality of CG resources or a plurality of CG PUSCHs in one CG resource.

For example, when there is less data (data rate is less than B), the UE uses/activates/resumes only one CG resource or only one CG PUSCH in one CG resource, or uses/activates/resumes only a default CG or only a CG PUSCH, or uses/activates/resumes only the first CG resource in a plurality of CGs or only the first CG PUSCH in one CG resource, or uses/activates/resumes only a CG resource, in a plurality of CGs, with an index being a special value or only a CG PUSCH, in one CG resource, with an index being a special value (for example, one or more of a maximum index, a minimum index, a maximum HARQ process identifier (ID), a minimum HARQ process ID, or the like).

(3) In at least one embodiment, the performing, by a terminal device, reporting based on at least one of configuration information, a CG resource, or a service feature may include:
reporting, by the terminal device based on the CG resource and the service feature, the data packet information or information about deactivation or suspending of the CG resource to the network device, for example, if the CG resource is to be deactivated/suspended, the UE reports deactivation or suspending of the CG resource to a network.

In at least one embodiment, the reporting information about deactivation or suspending of the CG resource to the network device may include:
reporting, by the terminal device by using an activated or resumed CG resource, the data packet information or the information about deactivation or suspending of the CG resource to the network device, for example, the UE reports the information by using the activated or resumed CG resource; or
reporting, by the terminal device by using an uplink resource, the data packet information or the information about deactivation or suspending of the CG resource to the network device, for example, the UE reports the information by using another UL resource; or,
reporting, by the terminal device by using uplink signalling, the data packet information or the information about deactivation or suspending of the CG resource to the network device, for example, the UE reports the information by using UL signaling ((a medium access control control element (MAC CE)/uplink control information (UCI)/radio resource control (RRC)).

(4) In at least one embodiment, the information about deactivation or suspending of the CG resource includes at least one of the following:
an indication/request for deactivating or suspending the CG resource;
data volume information currently to be transmitted (for the first LCH or service); or
a to-be-deactivated or to-be-suspended CG or CG PUSCH.

(5) In at least one embodiment, the CG resource for deactivation/suspending includes at least one of the following:
a deactivated or suspended CG is not multiplexed with UCI information, or does not carry UCI information, or fails to be multiplexed with uplink control information;
the deactivated or suspended CG is not used for transmission;
the deactivated or suspended CG is not used for transmission of a MAC CE and/or padding;
it is determined that the deactivated or suspended CG is skipped;
it is determined that the deactivated or suspended CG is a low-priority resource;
the deactivated or suspended CG is not capable of being transmitted;
transmission is performed with the deactivated or suspended CG skipped; or
the deactivated or suspended CG has the lowest priority in a case of resource conflict.

(6) In at least one embodiment, the method may further include: reporting, by the terminal device, the service feature or the data packet information to the network device, where the service feature or the data packet information is used for the network device to indicate that the CG resource is to be deactivated or suspended.

For example, the UE may not deactivate/suspend a CG, but first report a service feature, such as data packet information, to the network device, so that the network device dynamically indicates that the CG resource is to be deactivated/suspended (which may be that the network device indicates that the CG resource is to be deactivated or suspended compared with that the UE directly deactivates/suspends a CG, providing an optional solution; however, this solution will increase a delay, and has a relatively poor effect on improving system capacity).

In embodiments of this application, a terminal device receives configuration information sent by a network device, and/or a configured grant CG resource configured by the network device; and the terminal device performs, based on at least one of configuration information, a CG resource, or a service feature, at least one of configuring of the CG resource, determining of use of the CG resource, data transmission by using the CG resource, or reporting. For a case in which a data rate of a service is variable, a manner in which a UE automatically activates or deactivates a CG may be introduced. In this case, the UE performs reporting to indicate the information for a base station, so that the network device may allow a deactivated CG location to be used by another UE for transmission, thereby improving system capacity. In this application, the terminal device performs activation/resuming, and/or deactivation/suspending on the CG resource. The behavior herein is an adjustment automatically performed by the UE, not an adjustment performed according to existing CG activation/deactivation downlink control information (DCI).

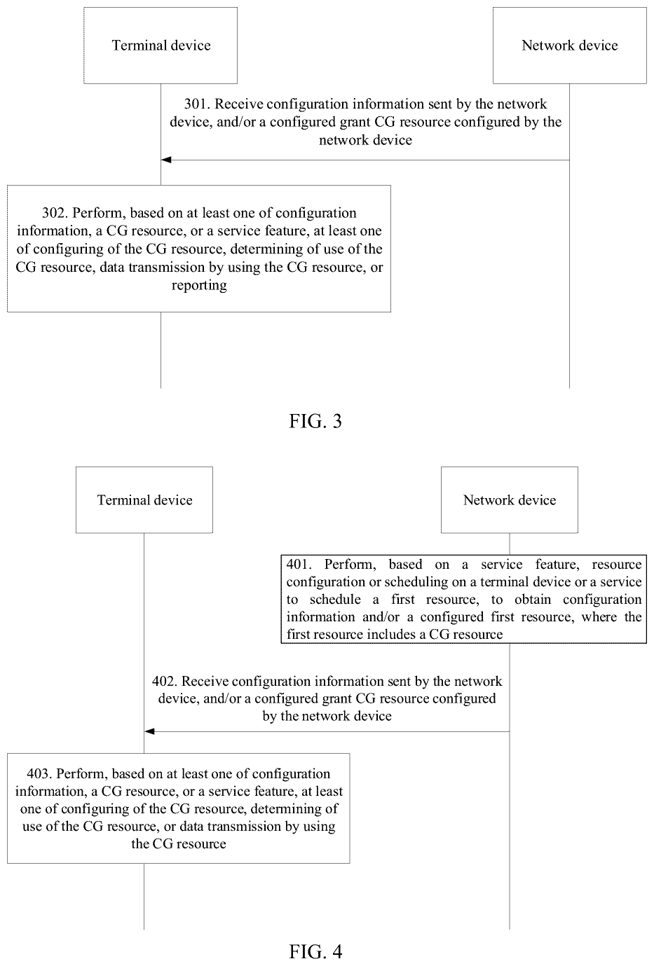

As shown in FIG. 3, FIG. 3 is a schematic diagram of a method for transmitting an extended reality XR service according to another embodiment of this application, which may include the following steps.

301. A terminal device receives configuration information sent by a network device, and/or a configured grant CG resource configured by the network device.

In at least one embodiment, the configuration information includes at least one of the following:
a. a plurality of CG resources;
b. one CG resource;
c. a first L2 parameter;
d. a second L2 parameter;
e. a first L1 parameter;
f. a second L1 parameter;
g. a mapping relationship or an association relationship between a first logical channel LCH and the CG resource, or a logical channel mapping limitation;
h. that the CG resource is configured by using a radio resource control reconfiguration message or through a CG configuration;
i. that a type of the CG resource is CG Type1 and/or CG Type2;
j. a parameter corresponding to a first condition and a second condition;
k. an enabling or activation indication corresponding to the first condition and the second condition;
l. an enabling or activation indication corresponding to a first case and a second case; or
m. an enabling or activation indication for the terminal device to automatically perform an L1/L2 parameter change.

(1) In at least one embodiment, in a case that the configuration information includes the plurality of CG resources, at least one of the following is included:
that each periodicity of at least one of the plurality of CG resources includes one or more CG resource locations;
that resource locations of the plurality of CG resource locations are consecutive in one time period;
that different hybrid automatic repeat request HARQ processes are used for resource locations of the plurality of CG resource locations in one time period;
a binding relationship of the plurality of CG resources; or a default CG resource in the plurality of CG resources.

For example, one time period may refer to one or more CG periodicities. That resource locations are consecutive may be that resource locations are consecutive between slots or in a slot.

(2) In at least one embodiment, in a case that the configuration information includes the one CG resource, at least one of the following is included:
that each periodicity of the one CG resource includes one or more CG resource locations;
that resource locations of the plurality of CG resource locations are consecutive in one periodicity;
that different hybrid automatic repeat request HARQ processes are used for resource locations of the plurality of CG resource locations in one periodicity;
a default CG resource location in the one CG resource; or
a default CG resource location in the plurality of CG resource locations.

For example, one periodicity may refer to one CG periodicity. That resource locations are consecutive may be that resource locations are consecutive between slots or in a slot.

(3) In at least one embodiment, the configuration information is in granularity of at least one of the following: an LCH/a DRB/a MAC entity/a PDCP/a UE/a CC/a CG.

For example, the foregoing j, k, l, and m may be for the LCH/the DRB/the MAC entity/the PDCP/the UE/the CC/the CG.

(4) In at least one embodiment, at least one of the following is included:
the first LCH corresponds to an XR service;
the CG resource is associated with the first LCH, or the first LCH is capable of being mapped to the CG resource;
the CG resource is associated with only the first LCH;
the first LCH is associated with only the CG resource;
in the first case, the CG resource uses the first LCH mapping relationship; or
in the second case, a first part of the CG resource uses the first LCH mapping relationship.

Exemplarily, in the first case, the first mapping relationship is used for the CG resource; or in the second case, the first mapping relationship is used for a first part of the CG resource. The first part of the CG resource is one CG resource or one CG PUSCH in one CG resource, or a default CG or CG PUSCH, or the first CG resource in a plurality of CGs or the first CG PUSCH in one CG resource, or a CG resource, in a plurality of CGs, with an index being a special value or a CG PUSCH, in one CG resource, with an index being a special value (for example, a maximum index, a minimum index, a maximum HARQ process ID, a minimum HARQ process ID, or the like).

(5) In at least one embodiment, in a case that the configuration information includes the second L2 parameter, the second L2 parameter includes a second LCH mapping relationship, and the second LCH mapping relationship includes a mapping relationship between a plurality of LCHs and the CG resource.

In at least one embodiment, at least one of the following is included:
the plurality of LCHs include a first LCH;
the first LCH corresponds to an XR service;
the CG resource is associated with the first LCH, and is associated with another LCH;
the CG resource is associated with only the first LCH;
the first LCH is associated with only the CG resource;
in the second case, the CG resource uses the second mapping relationship; or
in the second case, a second part of the CG resource uses the second LCH mapping relationship.

Exemplarily, in the second case, the second LCH mapping relationship is used for the CG resource; or in the second case, the second LCH mapping relationship is used for the second part of the CG resource. The second part of the CG resource is a resource, different from the first part, in the CG resource.

(6) In at least one embodiment, in a case in which the configuration information includes the first L1 parameter, the first L1 parameter includes a modulation and coding scheme (MCS) parameter.

In at least one embodiment, at least one of the following is included:
in the first case, the CG resource uses the first L1 parameter; or
in the second case, a first part of the CG resource uses the first L1 parameter.

Exemplarily, in the first case, the first L1 parameter is used for the CG resource; or in the second case, the first L1 parameter is used for a part of the CG resource. The first part of the CG resource is one CG resource or one CG PUSCH in one CG resource, or a default CG or CG PUSCH, or the first CG resource in a plurality of CGs or the first CG PUSCH in one CG resource, or a CG resource, in a plurality of CGs, with an index being a special value or a CG PUSCH, in one CG resource, with an index being a special value (for example, a maximum index, a minimum index, a maximum HARQ process ID, a minimum HARQ process ID, or the like).

(7) In at least one embodiment, in a case that the configuration information includes the second L1 parameter, the second L1 parameter includes an MCS parameter.

In at least one embodiment, at least one of the following is included:
in the second case, the CG resource uses the second L1 parameter; or
in the second case, a second part of the CG resource uses the second L1 parameter.

Exemplarily, in the second case, the second L1 parameter is used for the CG resource; or in the second case, the second L1 parameter is used for the second part of the CG resource. The second part of the CG resource is a resource, different from the first part, in the CG resource.

302. The terminal device performs, based on at least one of configuration information, a CG resource, or a service feature, at least one of configuring of the CG resource, determining of use of the CG resource, data transmission by using the CG resource, or reporting.

In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

(1) In at least one embodiment, the performing determining of use of the CG resource, or the performing data transmission by using the CG resource includes at least one of the following:
performing transmission of the CG resource by using the first L1 parameter (for example, an MCS parameter) and/or the second L1 parameter (for example, an MCS parameter); or
performing transmission of the CG resource by using the first L2 parameter (for example, an LCP mapping mechanism) and/or the second L2 parameter (for example, an LCP mapping mechanism).

(2) In at least one embodiment, the performing transmission of the CG resource by using the first L1 parameter/the second L1 parameter may include: when data packet information meets a first condition, and/or according to a third enabling or activation indication of the network device, determining that the first case is met, or performing transmission by using the first L1 parameter/the second L1 parameter.

The first condition includes at least one of the following:
the data packet information is greater than or equal to a first threshold;
a data packet arrives at a first time, for example, the first time may present periodically, or may present aperiodically; the first time may be indicated by a core network (CN) or an application layer; or the first time is a time different from a second time; or
a data packet is of a first specific type (for example, a full frame).

For example, when there is more data (data rate is greater than A), the UE transmits a plurality of CG resources or a plurality of CG PUSCHs in one CG resource by using first LCH mapping limitation or MCS.

(3) In at least one embodiment, the performing transmission of the CG resource by using the first L1 parameter/the second L2 parameter may include: when data packet information meets a second condition, and/or according to a fourth enabling or activation indication of the network device, determining that the second case is met, or performing transmission by using the second L1 parameter/the second L2 parameter, or performing transmission by using the first L1/L2 parameter and the second L1/L2 parameter.

The second condition includes at least one of the following:
the data packet information is less than a second threshold;
a data packet arrives at the second time, for example, the second time may present periodically, or may present aperiodically; the second time may be indicated by a CN or an application layer; or the second time is a time different from the first time; or
a data packet is of a second specific type, for example, a non-full frame or a delta frame of a full frame.

(4) In at least one embodiment, the performing, by a terminal device, reporting, based on at least one of configuration information, a CG resource, or a service feature may include: reporting, by the terminal device, first information to the network device, where the first information includes at least one of the following:
a service feature, a data-volume-change indication, data volume information, the data packet information, or an L1/L2 parameter to be used.

(5) In at least one embodiment, the reporting, by the terminal device, first information to the network device may include:
reporting, by the terminal device, the first information to the network device by using the CG resource; or
reporting, by the terminal device, the first information to the network device by using an uplink resource, for example, the UE reports the information by using another UL resource; or,
reporting, by the terminal device, the first information to the network device by using uplink signalling, for example, the UE reports the information by using UL signaling (MAC CE/UCI/RRC).

(6) In at least one embodiment, the method may further include: reporting, by the terminal device, the service feature or the data packet information to the network device, where the service feature or the data packet information is used for the network device to indicate that an L1/L2 parameter change is to be performed.

For example, the UE may alternatively not perform a first L1/L2 parameter change or a second L1/L2 parameter change, but first report the service feature, such as data packet information, to the network device, so that the network device dynamically indicates an updated L1/L2 parameter (compared with that the UE directly performs the first L1/L2 parameter change or the second L1/L2 parameter change, indication may be performed by the network device, providing an optional solution; however, this solution will increase a delay, and has a relatively poor effect on improving system capacity).

In embodiments of this application, a terminal device receives configuration information sent by a network device, and/or a configured grant CG resource configured by the network device; and the terminal device performs, based on at least one of configuration information, a CG resource, or a service feature, at least one of configuring of the CG resource, determining of use of the CG resource, data transmission by using the CG resource, or reporting. For a case in which a data rate of a service is variable, an LCP mapping change manner or an L1 parameter (such as MSC) change manner may be introduced, so that resources may be used by another LCH, reliability of the XR service may be improved (avoiding retransmission), and system capacity may be improved. In this application, the terminal device adjusts an L1/L2 parameter, so that the CG resource may be used for transmission of another LCH, or reliability of a first LCH is improved to avoid retransmission. The behavior herein is an adjustment automatically performed by a UE. For one LCH, herein a plurality of sets of L1/L2 parameters are required to be configured, not only one set of L1/L2 parameters is configured according to an existing case.

As shown in FIG. 4, FIG. 4 is a schematic diagram of a method for transmitting an extended reality XR service according to another embodiment of this application, which may include the following steps.

401. A network device performs, based on a service feature, resource configuration or scheduling on a terminal device or a service to schedule a first resource, to obtain configuration information and/or a configured first resource, where the first resource includes a CG resource.

In at least one embodiment, at least one of the configuration information, the CG resource, or the service feature is used to perform at least one of configuring of the CG resource, determining of use of the CG resource, or data transmission by using the CG resource.

In at least one embodiment, at least one of the configuration information, the CG resource, or the service feature is used to determine use of the CG resource directly/automatically/based on a condition, or performing data transmission by using the CG resource directly/automatically/based on a condition.

(1) In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

(2) In at least one embodiment, the service feature is obtained through at least one of an indication of a core network device, an indication of an application layer, or reporting of the terminal device.

(3) In at least one embodiment, the service feature corresponds to at least a first LCH; or
the service feature is specific for the terminal device; or
the service is an XR service; or
the network device is a base station.

(4) In at least one embodiment, the first resource includes the CG resource, and the configuration information includes at least one of the following:
a. a plurality of CG resources;
b. one CG resource;
c. a mapping relationship or an association relationship between a first logical channel LCH and the CG resource, or a logical channel mapping limitation;
d. that the CG resource is configured by using a radio resource control reconfiguration message or through a CG configuration;
e. that the CG resource is used for activating/resuming, or used for deactivating/suspending;
f. that a type of the CG resource is CG Type1 and/or CG Type2;
g. a parameter corresponding to a first condition and a second condition, where the first condition and the second condition are used for activating/resuming or used for deactivating/suspending;
h. an enabling or activation indication corresponding to the first condition and the second condition;
i. an enabling or activation indication corresponding to a first case and a second case; or
j. an enabling or activation indication for the terminal device to perform, automatically or based on a condition, activating/resuming and/or deactivating/suspending on the first resource.

(5) In at least one embodiment, in a case that the configuration information includes the plurality of first resources, at least one of the following is included:
that each periodicity of each of the plurality of first resources includes one or more first resource locations;
that resource locations of the plurality of first resource locations are consecutive in one time period;
that different hybrid automatic repeat request HARQ processes are used for resource locations of the plurality of first resource locations in one time period;
a binding relationship of the plurality of first resources; or
a default first resource in the plurality of first resources.

(6) In at least one embodiment, in a case that the configuration information includes the one first resource, at least one of the following is included:
that each periodicity of the one first resource includes one or more first resource locations;
that resource locations of the plurality of first resource locations are consecutive in one periodicity;
that different hybrid automatic repeat request HARQ processes are used for resource locations of the plurality of first resource locations in one periodicity; or
a default first resource location in the plurality of first resource locations.

(7) In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or
the first LCH is associated with only the first resource.

(8) In at least one embodiment, the configuration information is in granularity of at least one of the following: an LCH/a DRB/a MAC entity/a PDCP/a UE/a CC/a CG/SPS.

For example, the foregoing g, h, i, and j may be for the LCH/the DRB/the MAC entity/the PDCP/the UE/the CC/the CG.

402. The terminal device receives configuration information sent by the network device, and/or a configured grant CG resource configured by the network device.

403. The terminal device performs, based on at least one of configuration information, a CG resource, or a service feature, at least one of configuring of the CG resource, determining of use of the CG resource, or data transmission by using the CG resource.

(1) In at least one embodiment, the performing determining of use of the CG resource, or the performing data transmission by using the CG resource includes at least one of the following: performing activation, resuming, deactivation, or suspending on the CG resource automatically or based on a condition.

1) In at least one embodiment, the performing activation, resuming, deactivation, or suspending on the CG resource automatically or based on a condition may include: when data packet information meets a first condition, and/or according to a first enabling or activation indication of the network device, automatically performing activation or resuming on the CG resource, where the first condition includes at least one of the following:
the data packet information is greater than or equal to a first threshold;
a data packet arrives at a first time, for example, the first time may present periodically, or may present aperiodically; the first time may be indicated by a core network (CN) or an application layer; or the first time is a time different from a second time; or
a data packet is of a first specific type (for example, a full frame).

For example, when there is more data (data rate is greater than A), a UE activates/resumes a plurality of CG resources or a plurality of CG physical uplink shared channels (PUSCH) in one CG resource.

2) In at least one embodiment, the performing activation, resuming, deactivation, or suspending on the CG resource automatically or based on a condition may include: when data packet information meets a second condition, and/or according to a second enabling or activation indication of the network device, automatically performing activation or resuming on the CG resource.

The second condition includes at least one of the following:
the data packet information is less than a second threshold;
a data packet arrives at the second time, for example, the second time may present periodically, or may present aperiodically; the second time may be indicated by a CN or an application layer; or the second time is a time different from the first time; or
a data packet is of a second specific type, for example, a non-full frame or a delta frame of a full frame.

For example, when there is less data (data rate is less than B), a UE reactivates/suspends a plurality of CG resources or a plurality of CG PUSCHs in one CG resource.

For example, when there is less data (data rate is less than B), the UE uses/activates/resumes only one CG resource or only one CG PUSCH in one CG resource, or uses/activates/resumes a default CG or a CG PUSCH, or uses/activates/resumes only the first CG resource in a plurality of CGs or only the first CG PUSCH in one CG resource, or uses/activates/resumes only a CG resource, in a plurality of CGs, with an index being a special value or only a CG PUSCH, in one CG resource, with an index being a special value (for example, one or more of a maximum index, a minimum index, a maximum HARQ process identifier (ID), a minimum HARQ process ID, or the like).

(2) In at least one embodiment, the CG resource for deactivation/suspending includes at least one of the following:
a deactivated or suspended CG is not multiplexed with UCI information, or does not carry UCI information, or fails to be multiplexed with uplink control information;
the deactivated or suspended CG is not used for transmission;
the deactivated or suspended CG is not used for transmission of a MAC CE and/or padding;
it is determined that the deactivated or suspended CG is skipped;
it is determined that the deactivated or suspended CG is a low-priority resource;
the deactivated or suspended CG is not capable of being transmitted;
transmission is performed with the deactivated or suspended CG skipped; or
the deactivated or suspended CG has the lowest priority in a case of resource conflict.

(3) In at least one embodiment, the performing, based on at least one of configuration information, a CG resource, or a service feature by a terminal device, at least one of configuring of the CG resource, determining of use of the CG resource, or data transmission by using the CG resource includes: performing, based on at least one of the configuration information, the CG resource, or the service feature by the terminal device, determining of use of the CG resource directly or automatically or based on a condition, or data transmission directly by using the CG resource.

(4) In at least one embodiment, the method may further include:
configuring or scheduling, by the network device, a first resource or a resource location that is not used by the terminal device for another terminal device; or
at a first resource or a resource location that is not used by the terminal device, scheduling, by the network device, another UE to perform transmission, or allocating, by the network device, a transmission resource for another UE.

In embodiments of this application, a network device performs, based on a service feature, resource configuration or scheduling on a terminal device or a service to schedule a first resource, to obtain configuration information and/or a configured first resource, where the first resource includes a CG resource and/or an SPS resource; the terminal device receives the configuration information sent by the network device, and/or the configured grant CG resource configured by the network device; and the terminal device performs, based on at least one of the configuration information, the CG resource, or the service feature, at least one of configuring of the CG resource, determining of use of the CG resource, or data transmission by using the CG resource. The network device acquires a service feature, such as a change status of a data rate, for performing resource configuration. The terminal device performs, based on the configuration information and/or the service feature to automatically activate or deactivate a CG, to adapt to service changes. In addition, an unused resource may be used by another terminal device to improve system capacity. In this application, the network device performs resource configuration or scheduling based on a service feature, for example, data packet information of the terminal device. The terminal device performs activation/resuming and/or deactivation/suspending on the CG resource. The behavior herein is an adjustment automatically performed by the terminal device, not an adjustment performed according to existing CG activation/deactivation DCI. In addition, automatic deactivation restricts a MAC CE from using an exciting CG, reducing resource waste.

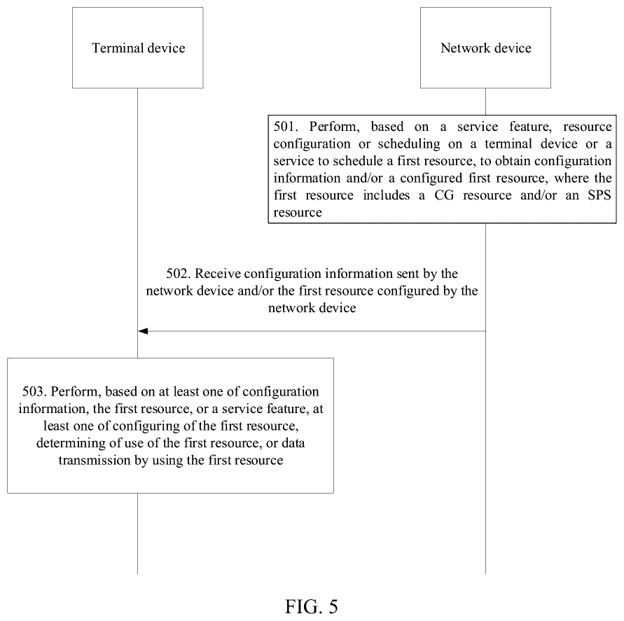

As shown in FIG. 5, FIG. 5 is a schematic diagram of a method for transmitting an extended reality XR service according to another embodiment of this application, which may include the following steps.

501. A network device performs, based on a service feature, resource configuration or scheduling on a terminal device or a service to schedule a first resource, to obtain configuration information and/or a configured first resource, where the first resource includes a CG resource and/or a semi-persistent scheduling (SPS) resource.

In at least one embodiment, the configuration information, and/or the configured first resource is used to perform at least one of configuring of the first resource, determining of use of the first resource, or data transmission by using the first resource.

(1) In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

(2) In at least one embodiment, the service feature is obtained through at least one of an indication of a core network device, an indication of an application layer, or reporting of the terminal device.

(3) In at least one embodiment, the service feature corresponds to at least a first LCH; or
the service feature is specific for the terminal device; or
the service is an XR service; or
the network device is a base station.

(4) In at least one embodiment, the first resource includes the CG resource and/or the SPS resource, and the configuration information includes at least one of the following:
a plurality of first resources;
one first resource;
a mapping relationship or an association relationship between a first logical channel LCH and the first resource, or a logical channel mapping limitation;
that the first resource is configured by using a radio resource control reconfiguration message or through a first configuration; or
that a type of the CG resource is CG Type1 and/or CG Type2 in a case that the first resource includes the CG resource.

(5) In at least one embodiment, in a case that the configuration information includes the plurality of first resources, at least one of the following is included:
that each periodicity of each of the plurality of first resources includes one or more first resource locations;
that resource locations of the plurality of first resource locations are consecutive in one time period;
that different hybrid automatic repeat request HARQ processes are used for resource locations of the plurality of first resource locations in one time period;
a binding relationship of the plurality of first resources; or
a default first resource in the plurality of first resources.

(6) In at least one embodiment, in a case that the configuration information includes the one first resource, at least one of the following is included:
that each periodicity of the one first resource includes one or more first resource locations;
that resource locations of the plurality of first resource locations are consecutive in one periodicity;
that different hybrid automatic repeat request HARQ processes are used for resource locations of the plurality of first resource locations in one periodicity; or
a default first resource location in the plurality of first resource locations.

(7) In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or the first LCH is associated with only the first resource.

(8) In at least one embodiment, the first resource includes the CG resource and/or the SPS resource, and the service feature corresponds to different configuration information. For example, configuration information varies with service feature.

(9) In at least one embodiment, a size of the configured first resource, an L1 parameter, or an L2 parameter varies at different periodicities/different moments/different first locations. For example, a size of the configured resource or a quantity of configured resources, or the L1 parameter such as an MCS, or the L2 parameter such as LCH mapping varies at different periodicities, different moments, or different CG locations.

(10) In at least one embodiment, the configuration information is a superposition of a plurality of pieces of configuration information, and each of the plurality of pieces of configuration information is periodic or regular. For example, the configuration information may be superimposition of a plurality of pieces of configuration information. Each configuration information is periodic or regular.

502. The terminal device receives the configuration information sent by the network device and/or the first resource configured by the network device.

503. The terminal device performs, based on at least one of the configuration information, the first resource, or a service feature, at least one of configuring of the first resource, determining of use of the first resource, or data transmission by using the first resource.

In embodiments of this application, a network device performs, based on a service feature, resource configuration or scheduling on a terminal device or a service to schedule a first resource, to obtain configuration information and/or a configured first resource, where the first resource includes a CG resource and/or an SPS resource; the terminal device receives the configuration information sent by the network device and/or the first resource configured by the network device; and the terminal device performs, based on at least one of the configuration information, the first resource, or a service feature, at least one of configuring of the first resource, determining of use of the first resource, and data transmission by using the first resource. The NW acquires a service feature, such as a change status of a data rate, and performs resource configuration. The resource configuration reflects a service change. An existing CG configuration mode is modified to improve system capacity. In this application, the network device performs resource configuration or scheduling based on a service feature, for example, data packet information. Configuration information varies with service feature. For example, a size of the configured resource or a quantity of configured resources, or the L1 parameter such as an MCS, or the L2 parameter such as LCH mapping varies at different periodicities, different moments, or different CG locations.

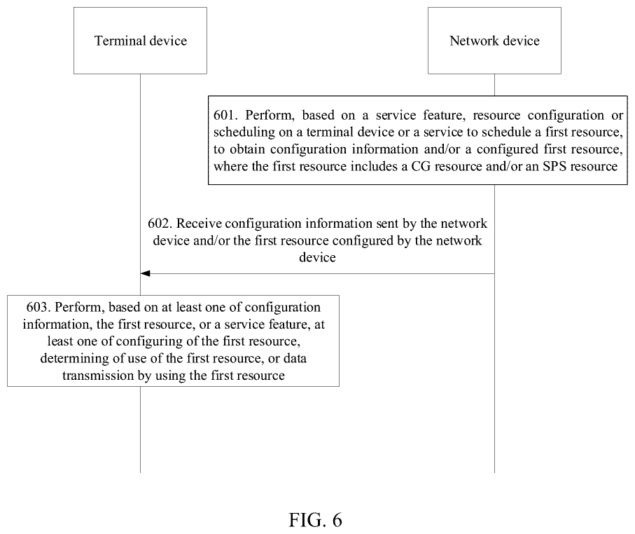

As shown in FIG. 6, FIG. 6 is a schematic diagram of a method for transmitting an extended reality XR service according to another embodiment of this application, which may include the following steps.

601. A network device performs, based on a service feature, resource configuration or scheduling on a terminal device or a service to schedule a first resource, to obtain configuration information and/or a configured first resource, where the first resource includes a CG resource and/or an SPS resource.

In at least one embodiment, the configuration information, and/or the configured first resource is used to perform at least one of configuring of the first resource, determining of use of the first resource, or data transmission by using the first resource.

(1) In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

(2) In at least one embodiment, the service feature is obtained through at least one of an indication of a core network device, an indication of an application layer, or reporting of the terminal device.

(3) In at least one embodiment, the service feature corresponds to at least a first LCH; or
the service feature is specific for the terminal device; or
the service is an XR service; or
the network device is a base station.

(4) In at least one embodiment, the first resource includes the CG resource and/or the SPS resource, and the configuration information includes at least one of the following:
a plurality of first resources;
that there is one CG PUSCH or SPS PUSCH in each first resource periodicity;
a mapping relationship or an association relationship between a first logical channel LCH and the first resource, or a logical channel mapping limitation;
that different HARQ processes are used for different first resources;
that different first resources are different in first resource periodicity;
that the plurality of first resources are combined to meet a service transmission requirement of a first LCH or the service feature;
that the first resource is configured by using a radio resource control reconfiguration message or through a first configuration; or
that a type of the CG resource is CG Type1 and/or CG Type2 in a case that the first resource includes the CG resource.

(5) In at least one embodiment, in a case that the configuration information includes the mapping relationship or the association relationship between a first logical channel LCH and the first resource, or the logical channel mapping limitation, at least one of the following is included:
the first LCH corresponds to an XR service;
the first resource is associated with the first LCH;
the first LCH is capable of being mapped to the first resource;
the plurality of first resources are associated with the first LCH;
the plurality of first resources are associated with the first LCH, and are not associated with another LCH;
the first resource is associated with only the first LCH; or
the first LCH is associated with only the first resource.

For example, a plurality of CG resources are associated with the first LCH. Further, a plurality of CG resources are not associated with another LCH; and the first LCH is capable of being mapped only to the plurality of CG resources.

602. The terminal device receives the configuration information sent by the network device and/or the first resource configured by the network device.

603. The terminal device performs, based on at least one of the configuration information, the first resource, or a service feature, at least one of configuring of the first resource, determining of use of the first resource, or data transmission by using the first resource.

In embodiments of this application, a network device performs, based on a service feature, resource configuration or scheduling on a terminal device or a service to schedule a first resource, to obtain configuration information and/or a configured first resource, where the first resource includes a CG resource and/or an SPS resource; the terminal device receives the configuration information sent by the network device and/or the first resource configured by the network device; and the terminal device performs, based on at least one of the configuration information, the first resource, or a service feature, at least one of configuring of the first resource, determining of use of the first resource, or data transmission by using the first resource. The network device acquires a service feature, such as a change status of a data rate, and configures a plurality of sets of CG resources, and the plurality of sets of CG resources are combined to meet a service change. In this embodiment, existing CG configuration information does not change. In this application, the network device performs resource configuration or scheduling based on a service feature, for example, data packet information. A corresponding service feature is configured with a plurality of sets of CG resources. In at least one embodiment, there is one CG PUSCH in each CG resource periodicity. Different CG resources are different in CG resource periodicity. A plurality of CG resources are associated with the first LCH. The plurality of CG resources are combined to meet a service transmission requirement of the first LCH or the service feature.

It should be noted that in embodiments illustrated in FIG. 5 and FIG. 6, the terminal device performs, based on at least one of the configuration information, the first resource, or the service feature, at least one of configuring of the first resource, determining of use of the first resource, or data transmission by using the first resource. Reference may be made to the description in foregoing embodiments, and details are not described herein again.

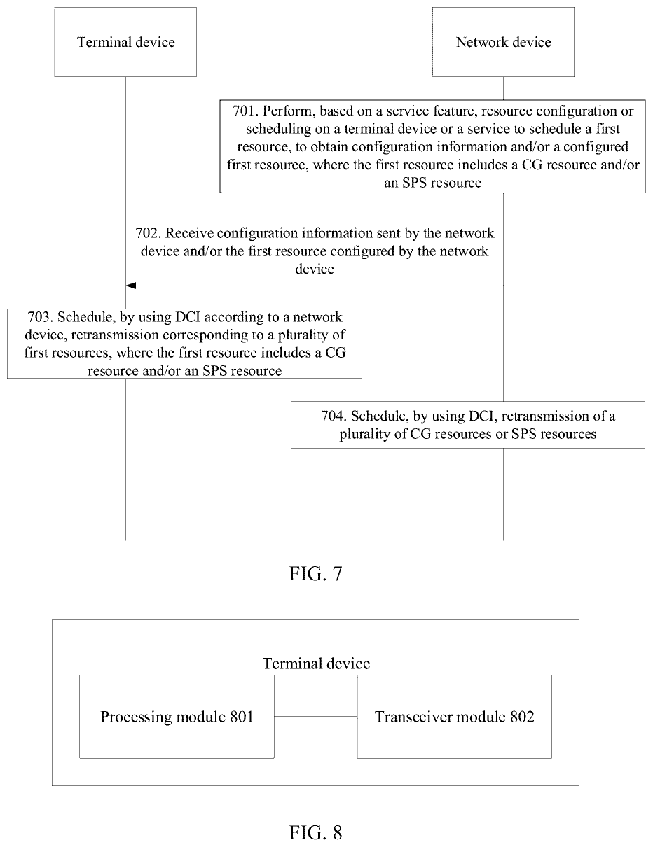

As shown in FIG. 7, FIG. 7 is a schematic diagram of a method for transmitting an extended reality XR service according to another embodiment of this application, which may include the following steps.

701. A network device performs, based on a service feature, resource configuration or scheduling on a terminal device or a service to schedule a first resource, to obtain configuration information and/or a configured first resource, where the first resource includes a CG resource and/or an SPS resource.

In at least one embodiment, the configuration information, and/or the configured first resource is used to perform at least one of configuring of the first resource, determining of use of the first resource, or data transmission by using the first resource.

(1) In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

(2) In at least one embodiment, the service feature is obtained through at least one of an indication of a core network device, an indication of an application layer, or reporting of the terminal device.

(3) In at least one embodiment, the service feature corresponds to at least a first LCH; or
the service feature is specific for the terminal device; or
the service is an XR service; or
the network device is a base station.

(4) In at least one embodiment, the configuration information includes at least one of the following:
that a first periodicity includes a periodicity of a service feature change or an integer multiple of T, where T is a service periodicity or a data packet periodicity, or a data packet arrival periodicity;
that the first periodicity includes first duration and/or second duration, the first duration is the periodicity of the service feature change or duration occupied by the service feature change, and the second duration is a service periodicity or a data packet periodicity, or the data packet arrival periodicity;
a plurality of CG PUSCHs or SPS PUSCHs or first resources in the one first periodicity;
an LCP relationship between a first LCH and the first resource; or
that a type of the CG resource is CG Type1 and/or CG Type2 in a case that the first resource includes the CG resource.

In at least one embodiment, the first periodicity is a CG periodicity or an SPS periodicity.

In at least one embodiment, the first periodicity is a product of X and T, and X is a quantity of resources of a CG PUSCH in one CG periodicity, or a quantity of variable data packets, or a quantity of variable resources, or a quantity of variable data-packet-size levels, or a quantity of variable resource-size levels; or X is a quantity of resources of an SPS PUSCH in one SPS periodicity, or a quantity of variable data packets, or a quantity of variable resources, or a quantity of variable data-packet-size levels, or a quantity of variable resource-size levels.

For example, one CG periodicity=X*T. T is a service periodicity or a data packet periodicity, or a data packet arrival periodicity. In at least one embodiment, X is a quantity of resources of a CG PUSCH in one CG periodicity, or X is a quantity of variable data packets, or a quantity of variable resources, or a quantity of variable data-packet-size levels, or a quantity of variable resource-size levels.

(5) In at least one embodiment, in a case that the configuration information includes the plurality of CG PUSCHs or SPS PUSCHs or first resources, at least one of the following is included:
different CG PUSCHs or SPS PUSCHs or first resources correspond to different start locations in time domain;
different CG PUSCHs or SPS PUSCHs or first resources occupy different sizes of units in time domain, and/or occupy different quantities of resources in frequency domain;
different CG PUSCHs or SPS PUSCHs or first resources use different L1 parameters; or
different CG PUSCHs or SPS PUSCHs or first resources use different L2 parameters.

1) In at least one embodiment, the start location in time domain is as follows:
locations, configured through radio resource control RRC or indicated by downlink control information DCI, of different CG PUSCHs or SPS PUSCHs or the first resources; or
a location, configured through RRC or indicated in DCI, of a specific CG PUSCH or a specific SPS PUSCH or the first resource; or
a start location, configured through the RRC or indicated in the DCI, of the first CG PUSCH or the first SPS PUSCH or the first resource, and an offset, configured through the RRC or indicated in the DCI, of another CG PUSCH or another SPS PUSCH or the first resource relative to the first CG PUSCH or the first SPS PUSCH or the first resource; or
a start location, configured through the RRC or indicated in the DCI, of a specific CG PUSCH or a specific SPS PUSCH or the first resource, and an offset, configured through the RRC or indicated in the DCI, of another CG PUSCH or another SPS PUSCH or the first resource relative to the specific CG PUSCH or the specific SPS PUSCH or the first resource.

For example, through RRC configuration, for example, CG config, start locations (such as time domain offsets) of different CG PUSCHs or CG resources are configured, or a start location (such as a time domain offset) of the first CG PUSCH or CG resource and an offset of another CG PUSCH or CG resource relative to the first CG PUSCH or CG resource are indicated. Alternatively, in DCI, such as CG activation signaling, start locations (such as time domain offsets) of different CG PUSCHs or CG resources are indicated, or a start location (such as a time domain offset) of the first CG PUSCH or CG resource and an offset of another CG PUSCH or CG resource relative to the first CG PUSCH or CG resource are indicated.

2) In at least one embodiment, the sizes of units in time domain and/or the quantities of resources in frequency domain and/or a location in frequency domain are as follows:
sizes in time domain, and/or quantities in frequency domain, and/or locations in frequency domain, configured through RRC or indicated in DCI, of different CG PUSCHs or SPS PUSCHs or the first resources; or
a size in time domain, and/or a quantity in frequency domain, and/or a location in frequency domain, configured through RRC or indicated in DCI, of a specific CG PUSCH or a specific SPS PUSCH or the first resource; or
a size in time domain, and/or a quantity in frequency domain, and/or a location in frequency domain, configured through the RRC or indicated in the DCI, of the first CG PUSCH or the first SPS PUSCH or the first resource, and an offset of another CG PUSCH or another SPS PUSCH or the first resource relative to the first CG PUSCH or the first SPS PUSCH or the first resource; or
a size in time domain, and/or a quantity in frequency domain, and/or a location in frequency domain, configured through the RRC or indicated in the DCI, of a specific CG PUSCH or a specific SPS PUSCH or the first resource, and an offset of another CG PUSCH or another SPS PUSCH or the first resource relative to the specific CG PUSCH or the specific SPS PUSCH or the first resource.

For example, through RRC configuration, for example, CG config, sizes/lengths of time domain resources (for example, slots/symbols) and/or sizes of frequency domain resources (for example, a quantity of physical resource blocks (PRB) or frequency domain resource allocation) of different CG PUSCHs or CG resources are configured, or a size/length of a time domain resource of the first CG PUSCH or CG resource and an offset of another CG PUSCH or CG resource relative to the first CG PUSCH or CG resource are indicated. Alternatively, in DCI, such as CG activation DCI, sizes/lengths of time domain resources (for example, slots/symbols) and/or sizes of frequency domain resources (for example, a quantity of PRBs or frequency domain resource allocation) of different CG PUSCHs or CG resources are indicated, or a size/length of a time domain resource of the first CG PUSCH or CG resource and an offset of another CG PUSCH or CG resource relative to the first CG PUSCH or CG resource are indicated.

3) in at least one embodiment, the L1 parameter is as follows:
L1 parameters, configured through RRC or indicated in DCI, of different CG PUSCHs or different SPS PUSCHs or the first resource; or
an L1 parameter, configured through RRC or indicated in DCI, of a specific CG PUSCH or a specific SPS PUSCH or the first resource; or
an L1 parameter, configured through the RRC or indicated in the DCI, of the first CG PUSCH or the first SPS PUSCH or the first resource, and an offset of another CG PUSCH or another SPS PUSCH or the first resource relative to the first CG PUSCH or the first SPS PUSCH or the first resource; or
an L1 parameter, configured through the RRC or indicated in the DCI, of a specific CG PUSCH or a specific SPS PUSCH or the first resource, and an offset of another CG PUSCH or another SPS PUSCH or the first resource relative to the specific CG PUSCH or the specific SPS PUSCH or the first resource.

For example, through RRC configuration, for example, CG config, L1 parameters (such as MCS) of different CG PUSCHs or CG resources are configured or an L1 parameter (such as MCS) of the first CG PUSCH or CG resource and an offset of another CG PUSCH or CG resource relative to the first CG PUSCH or CG resource are indicated. Alternatively, in DCI, such as CG activation DCI, L1 parameters (such as MCS) of different CG PUSCHs or CG resources are indicated, or an L1 parameter (such as MCS) of the first CG PUSCH or CG resource and an offset of another CG PUSCH or CG resource relative to the first CG PUSCH or CG resource are indicated.

(6) In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or
the first LCH is associated with only the first resource.

702. The terminal device receives configuration information sent by the network device and/or the first resource configured by the network device.

703. The terminal device schedules, by using DCI according to the network device, retransmission corresponding to a plurality of first resources, where the first resource includes a CG resource and/or an SPS resource.

In at least one embodiment, at least one of the following is included:
a retransmission resource is a second resource, and the second resource is a dynamically scheduled resource;
a retransmission resource is a dynamically scheduled resource;
the retransmission resource includes a plurality of pieces of resource information;
a retransmission resource includes common information and/or different information for different SPS/CGs;
retransmission resources correspond to different SPS/CGs respectively;
a UE performs retransmission on at least one SPS/CG by using a retransmission resource; or
retransmission resources correspond to different CG PUSCHs/SPS PDSCHs of a same SPS/CG respectively.

In at least one embodiment, the CG resource or the SPS resource or both include at least one of the following:
a plurality of CG resources and/or SPS resources; or
different CG PUSCHs/SPS PDSCHs of a same SPS/CG.

704. The network device schedules, by using DCI, retransmission of a plurality of CG resources or SPS resources.

In at least one embodiment, the plurality of CG resources are a grant for retransmission scheduling of at least one of the plurality of CG PUSCHs configured in one CG periodicity. The plurality of SPS resources are a grant for retransmission scheduling of at least one of the plurality of SPS PUSCHs configured in one SPS periodicity.

For example, the network device schedules retransmission of a plurality of resources by using one piece of DCI. For example, one piece of DCI indicates retransmission of a plurality of CG grants. The plurality of grants are grants for retransmission scheduling of at least one CG PUSCH in one configured CG periodicity.

In at least one embodiment, a result of scheduling is a dynamic grant (DG) resource.

In at least one embodiment, this application is used for uplink UL and for a scenario such as a case that a network knows data-packet change information and/or a data-packet change information is regular.

In embodiments of this application, a network device performs, based on a service feature, resource configuration or scheduling on a terminal device or a service to schedule a first resource, to obtain configuration information and/or a configured first resource, where the first resource includes a CG resource and/or an SPS resource. The terminal device receives configuration information sent by the network device and/or the first resource configured by the network device. The network device schedules retransmission of a plurality of CG resources or SPS resources by using DCI. According to a service feature, a network configures a CG resource, and there are a plurality of CG PUSCHs in one CG periodicity. In addition, the network indicates, by using RRC or DCI, transmission resources (including grant and HARQ) used by different CG PUSCHs, to meet transmission of an XR service with flexible and proper resource allocation ensured. In this application, the network device configures or activates a CG resource based on a service feature, such as data packet information. Specifically, more than one CG PUSCH is configured in one CG periodicity. The CG periodicity is X service periodicities or data packet periodicities.

Embodiment 1: (A UE performs activation/resuming, and/or deactivation/suspending on a CG resource. The behavior herein is an adjustment automatically performed by the UE, not an adjustment performed according to existing CG activation/deactivation DCI). A specific implementation procedure is as follows (for example, for a case that a network device does not know data-packet change information or data-packet change information is irregular):

1. The UE receives a CG resource configured by a network. Specifically, at least one of the following is included:
a) The CG resource is a plurality of CG resources. In at least one embodiment,
   i. each periodicity of one CG resource includes one or more CG resource locations;
   ii. for the plurality of CG resources, resource locations of a plurality of CG resource locations are consecutive in one time period;
   iii. for the plurality of CG resources, different hybrid automatic repeat request (HARQ) processes are used for resource locations of a plurality of CG resource locations in one periodicity;
   iv. a binding relationship of the plurality of CG resources is configured;
   v. a default CG resource in the plurality of CG resources is configured.
b) The CG resource is one CG resource. In at least one embodiment,
   i. each periodicity includes one or more CG resource locations;
   ii. resource locations of a plurality of CG resource locations are consecutive in one CG periodicity;
   iii. different HARQ processes are used for resource locations of the plurality of CG resource locations in one periodicity;
   iv. a default CG resource location in the plurality of CG resource locations is configured.
c) A link control protocol (LCP) mapping relationship between a first logical channel (LCH) and a CG resource is configured. In at least one embodiment,
   i. the first LCH corresponds to an XR service;
   ii. the CG is associated with only the first LCH, or only the first LCH may be mapped to the CG.
d) The CG resource is configured through RRC re config or CG config.
e) Activation/resuming or deactivation/suspending is configured for the CG resource.
f) The CG resource is of a CG Type1 and/or CG Type2.
g) A parameter corresponding to a first condition and a second condition is configured. In at least one embodiment, the configuration is for an LCH/a DRB/a MAC entity/a PDCP/a UE/a CC/a CG.
h) An enabling indication for a first case and a second case is configured. In at least one embodiment, the configuration is for an LCH/a DRB/a MAC entity/a PDCP/a UE/a CC/a CG.
i) An enabling indication for a parameter corresponding to a first condition and a second condition is configured. In at least one embodiment, the configuration is for an LCH/a DRB/a MAC entity/a PDCP/a UE/a CC/a CG.
j) An enabling indication for the UE to (automatically) perform activation/resuming and/or deactivation/suspending on the CG resource is configured. In at least one embodiment, the configuration is for an LCH/a DRB/a MAC entity/a PDCP/a UE/a CC/a CG.

2. Based on the CG resource and/or the configuration information configured in 1), the UE performs, based on a service feature such as data packet information, and/or a network enabling indication, determining of use of the CG resource, and/or data transmission by using the CG resource, and/or reporting (such as deactivation/suspending of a CG, activation/resuming, or data rate). Specifically, at least one of the following is included.
a) The data packet information is data-packet-size information, or data-volume-size information, or data rate information, a change status/rule/periodicity.
b) The determining of use of the CG resource, or data transmission by using the CG resource includes at least one of the following: (automatically) performing activation/resuming and/or deactivation/suspending on the CG resource.
c) The UE (automatically) performs, based on the service feature such as data packet information, and/or a network enabling indication, activation/resuming and/or deactivation/suspending on the CG resource. In at least one embodiment,
   i. if the service feature, such as data packet information, meets a first condition, and/or, based on a network enabling indication, the UE (automatically) performs activation/resuming on the CG resource.

The first condition includes at least one of the following: the data packet information is greater than or equal to a first threshold, a data packet arrives at a first time (the first time may present periodically, or may present aperiodically; the first time may be indicated by a CN or an application layer; or the first time is a time different from a second time), and a first data packet is of a specific type (for example, a full frame).

For example, when there is more data (data rate is greater than A), the UE activates/resumes a plurality of CG resources or a plurality of CG PUSCHs in one CG resource.
ii. If the service feature, such as data packet information, meets a second condition, and/or, based on a network enabling indication, the UE (automatically) performs deactivation/suspending on the CG resource.

The second condition is at least one of the following: the data packet information is less than a second threshold, a data packet arrives at a second time (the second time may present periodically, or may present aperiodically; the second time may be indicated by a CN or an application layer, or the second time is a time different from the first time), and the second data packet is of a specific type (for example, a non-full frame or a delta frame of a full frame).

For example, when there is less data (data rate is less than B), the UE reactivates/suspends a plurality of CG resources or a plurality of CG PUSCHs in one CG resource.

For example, when there is less data (data rate is less than B), the UE uses/activates/resumes only one CG resource or only one CG PUSCH in one CG resource, or uses/activates/resumes a default CG or a CG PUSCH, or uses/activates/resumes only the first CG resource in a plurality of CGs or the first CG PUSCH in one CG resource, or uses/activates/resumes only a CG resource, in a plurality of CGs, with an index being a special value or a CG PUSCH, in one CG resource, with an index being a special value (for example, one or more of a maximum index, a minimum index, a maximum HARQ process ID, a minimum HARQ process ID, or the like).
d) If the CG resource is to be deactivated/suspended, the UE reports deactivation or suspending of the CG resource to a network. In at least one embodiment, at least one of the following is included:
   i. the UE reports the information by using the activated/resumed CG resource;
   ii. the UE reports the information by using another UL resource;
   iii. the UE reports the information by using UL signaling (MAC CE/UCI/RRC); or
   iv. the information includes at least one of the following: an indication for deactivating/suspending the CG resource, data volume information currently to be transmitted (for a first LCH or a service), or a deactivated/suspended CG or CG PUSCH.
e) For the deactivated/suspended CG, in at least one embodiment:
   i. which cannot be multiplexed with UCI;
   ii. which cannot be transmitted or needs to be skipped; or
   iii. which has the lowest priority in case of resource conflict (grant or HARQ process).
f) In at least one embodiment, the UE may not perform deactivation/suspending on a CG, but first report a service feature, such as data packet information or a data rate change, to the network, so that the network dynamically indicates deactivation of the CG resource (compared with that the UE directly performs deactivation/suspending on the CG, this case has relatively large delay and relatively poor effect on improving system capacity).

Applicable scenario: For a case in which a data rate of a service changes, a manner in which a UE automatically activates or deactivates a CG may be introduced. In this case, the UE performs reporting to indicate the information for a base station, so that the network device may allow a location of a deactivated CG to be used by another UE for transmission, thereby improving system capacity.

Embodiment 2: (The UE adjusts an L1/L2 parameter, so that the CG resource may be used for transmission of another LCH, or reliability of a first LCH is improved to avoid retransmission. The behavior herein is an adjustment automatically performed by the UE. For one LCH, herein a plurality of sets of L1/L2 parameters are required to be configured, not only one set of L1/L2 parameters is configured according to an existing case.) A specific implementation procedure is as follows (for example, for a case that a network device does not know data-packet change information or data-packet change information is irregular):

1. The UE receives a CG resource configured by a network. Specifically, at least one of the following is included.
a) The CG resource is a plurality of CG resources. In at least one embodiment,
   i. each periodicity of one CG resource includes one or more CG resource locations;
   ii. for the plurality of CG resources, resource locations of a plurality of CG resource locations are consecutive in one time period;
   iii. for the plurality of CG resources, different HARQ processes are used for resource locations of a plurality of CG resource locations in one time period;
   iv. a binding relationship of the plurality of CG resources is configured;
   v. a default CG resource in the plurality of CG resources is configured.
b) The CG resource is one CG resource.
   i. each periodicity includes one or more CG resource locations;
   ii. resource locations of a plurality of CG resource locations are consecutive in one CG periodicity;
   iii. different HARQ processes are used for resource locations of the plurality of CG resource locations in one periodicity;
   iv. a default CG resource location in the plurality of CG resource locations is configured.
c) A first L2 parameter, for example, a first LCH mapping relationship is configured: configuring an LCH mapping relationship between a first LCH and a CG resource. In at least one embodiment,
   i. the first LCH corresponds to an XR service;
   ii. the CG is associated with only the first LCH, or only the first LCH may be mapped to the CG;
   iii. the first L2 parameter, for example, a usage manner of a first mapping relationship is configured:
      in a first case, the first mapping relationship is used for the CG resource;
      in a second case, the first mapping relationship is used for a first part of the CG resource.

The first part of the CG resource is one CG resource or one CG PUSCH in one CG resource, or a default CG or CG PUSCH, or the first CG resource in a plurality of CGs or the first CG PUSCH in one CG resource, or a CG resource, in a plurality of CGs, with an index being a special value or a CG PUSCH, in one CG resource, with an index being a special value (for example, a maximum index, a minimum index, a maximum HARQ process ID, a minimum HARQ process ID, or the like).
d) A second L2 parameter, for example, a second LCH mapping relationship is configured: configuring an LCH mapping relationship between a plurality of LCHs and a CG resource. In at least one embodiment,
   i. the plurality of LCHs include the first LCH;
   ii. the first LCH corresponds to an XR service;
   iii. the CG is associated with the first LCH, and also associated with another LCH;
   iv. the second L2 parameter, for example, a usage manner of a second LCH mapping relationship is configured:
      in the second case, the second LCH mapping relationship is used for the CG resource; or
      in the second case, the second LCH mapping relationship is used for a second part of the CG resource.

The second part of the CG resource is a resource, different from the first part, in the CG resource.
e) A first L1 parameter is configured. In at least one embodiment, the L1 parameter may be an MCS parameter. In at least one embodiment,
   i. a usage manner of the first L1 parameter is configured:
      in the first case, the first L1 parameter is used for the CG resource; or
      in the second case, the first L1 parameter is used for a first part of the CG resource.

The first part of the CG resource is one CG resource or one CG PUSCH in one CG resource, or a default CG or CG PUSCH, or the first CG resource in a plurality of CGs or the first CG PUSCH in one CG resource, or a CG resource, in a plurality of CGs, with an index being a special value or a CG PUSCH, in one CG resource, with an index being a special value (for example, a maximum index, a minimum index, a maximum HARQ process ID, a minimum HARQ process ID, or the like).
f) A second L1 parameter is configured. In at least one embodiment, the L1 parameter may be an MCS parameter. In at least one embodiment,
   i. a usage manner of the second L1 parameter is configured:
      in the second case, the second L1 parameter is used for the CG resource; or
      in the second case, the second L1 parameter is used for a second part of the CG resource.

The second part of the CG resource is a resource, different from the first part, in the CG resource.
g) The CG resource is configured through RRC re config or CG config.
h) The CG resource is of a CG Type1 and/or CG Type2.
i) A parameter corresponding to a first condition and a second condition is configured. In at least one embodiment, the configuration is for an LCH/a DRB/a MAC entity/a PDCP/a UE/a CC/a CG.
j) An enabling indication for a first case and a second case is configured. In at least one embodiment, the configuration is for an LCH/a DRB/a MAC entity/a PDCP/a UE/a CC/a CG.
k) An enabling indication for a parameter corresponding to a first condition and a second condition is configured. In at least one embodiment, the configuration is for an LCH/a DRB/a MAC entity/a PDCP/a UE/a CC/a CG.
1) An enabling indication for the UE to (automatically) perform an L1/L2 parameter change is configured. In at least one embodiment, the configuration is for an LCH/a DRB/a MAC entity/a PDCP/a UE/a CC/a CG.
2. Based on the CG resource and/or the configuration information configured in 1), the UE performs, based on a service feature such as data packet information, and/or a network enabling indication, determining of use of the CG resource, and/or data transmission by using the CG resource, and/or reporting (such as data rate). Specifically, at least one of the following is included.
a) The service feature, such as data packet information, is data-packet-size information, or data-volume-size information, or data rate information, a change status/rule/periodicity.
b) the determining of use of the CG resource, or data transmission by using the CG resource includes at least one of the following: performing transmission of the CG resource by using the first/second L1 parameter (for example, MCS); or performing transmission of the CG resource by using the first/second L2 parameter (for example, an LCP mapping limitation).
c) Based on the service feature, such as data packet information, and/or the network enabling indication, the use of the CG resource is determined, or data transmission is performed by using the CG resource. In at least one embodiment,
   i. If the service feature, such as data packet information, meets a first condition, and/or according to the network enabling indication, it is determined that the first condition is met, or transmission is performed by using the first L1/L2 parameter.

In at least one embodiment, a manner of the transmission is described in c tof in step 1. (In at least one embodiment, the network may be determined in a predefined manner without configuring a usage manner, or may be determined by the UE)

The first condition includes at least one of the following: the data packet information is greater than or equal to a first threshold, a data packet arrives at a first time (the first time may present periodically, or may present aperiodically; the first time may be indicated by a CN or an application layer; or the first time is a time different from a second time), and the first data packet is of a specific type (for example, a full frame).

For example, when there is more data (data rate is greater than A), the UE transmits a plurality of CG resources or a plurality of CG PUSCHs in one CG resource by using first LCH mapping limitation or MCS.
ii. If the service feature, such as data packet information, meets a second condition, and/or according to the network enabling indication, it is determined that the second condition is met, or transmission is performed by using the second L1/L2 parameter, or transmission is performed by using the first+second L1/L2 parameter.

In at least one embodiment, a manner of the transmission is described in c to fin step 1. (In at least one embodiment, the network may be determined in a predefined manner without configuring a usage manner, or may be determined by the UE).

The second condition is at least one of the following: the data packet information is less than a second threshold, a data packet arrives at a second time (the second time may present periodically, or may present aperiodically; the second time may be indicated by a CN or an application layer, or the second time is a time different from the first time), and the second data packet is of a specific type (for example, a non-full frame or a delta frame of a full frame).

For example, when there is less data (data rate is less than B), the UE transmits a plurality of CG resources or a specific CG PUSCH in one CG resource by using first LCH mapping limitation or MCS, and transmits another resource by using second LCH mapping limitation or MCS; and the specific one refers to a default one, any one, the first one, or one or more with an index being a special value (for example, a maximum index, a minimum index, a maximum HARQ process ID, a minimum HARQ process ID, or the like).
d) The UE reports a parameter usage change of a CG resource or a service feature (such as a data volume change) to the network. In at least one embodiment, at least one of the following is included:
   the UE reports the information by using the CG resource, or the UE reports the information by using another UL resource; or
   the UE reports the information by using UL signaling (MAC CE/UCI/RRC).

The information includes at least one of the following: a service feature, a data-volume-change indication, data volume information, or an L1/L2 parameter to be used.
e) In at least one embodiment, the UE may not perform first/second L1/L2 parameter change, but first report a service feature, such as data packet information or a data rate change, to the network, so that the network dynamically indicates an updated L1/L2 parameter (compared with that the UE directly performs the first/second L1/L2 parameter change, this case has a relatively large delay and a relatively poor effect on improving system capacity).

Applicable scenario: For a case in which a data rate of a service changes, an LCP mapping change manner or an L1 information change manner (MSC) is introduced, so that resources may be used by another LCH, or reliability of the XR service may be improved (avoiding retransmission), and system capacity may be improved.

Embodiment 3: (A network performs resource configuration or scheduling based on a service feature of a UE, such as data packet information. The UE performs activation/resuming and/or deactivation/suspending on the CG resource. The behavior herein is an adjustment automatically performed by the UE, not an adjustment performed according to existing CG activation/deactivation DCI. In addition, automatic deactivation restricts a MAC CE from using an exciting CG, reducing resource waste). A specific implementation procedure is as follows (for example, for a case that the network knows data-packet change information and/or data-packet change information is regular):
1. The network performs resource configuration or scheduling on the UE or a service based on a service feature. In at least one embodiment, at least one of the following is included.
a) The service feature includes at least one of the following: data packet information, which is data-packet-size information, or data-volume-size information, or data rate information, or a data-packet change information/rule/periodicity.
b) The service feature corresponds to at least a first LCH.
c) The service feature is UE-specific.
d) The service is an XR service.
e) The network is a base station.
f) The network acquires the service feature based on at least one of an indication of a core network, an indication of an application layer indication, or reporting of the UE.
g) A parameter corresponding to a first condition and a second condition is configured. In at least one embodiment, the configuration is for an LCH/a DRB/a MAC entity/a PDCP/a UE/a CC/a CG.
h) An enabling indication for a first case and a second case is configured. In at least one embodiment, the configuration is for an LCH/a DRB/a MAC entity/a PDCP/a UE/a CC/a CG.
i) An enabling indication for a parameter corresponding to a first condition and a second condition is configured. In at least one embodiment, the configuration is for an LCH/a DRB/a MAC entity/a PDCP/a UE/a CC/a CG.
j) An enabling indication for the UE to (automatically) perform activation/resuming and/or deactivation/suspending on the CG resource is configured. In at least one embodiment, the configuration is for an LCH/a DRB/a MAC entity/a PDCP/a UE/a CC/a CG.
k) A CG resource is configured for the service feature. At least one of the following is included.
   i. The CG resource is a plurality of CG resources. In at least one embodiment,
      each periodicity of one CG resource includes one or more CG resource locations;
      for the plurality of CG resources, resource locations of a plurality of CG resource locations are consecutive in one time period;
      for the plurality of CG resources, different HARQ processes are used for resource locations of a plurality of CG resource locations in one time period;
      a binding relationship of the plurality of CG resources is configured; or
      a default CG resource in the plurality of CG resources is configured.
   ii. The CG resource is one CG resource.
      Each periodicity includes one or more CG resource locations.
      Resource locations of a plurality of CG resource locations are consecutive in one CG periodicity.
      Different HARQ processes are used for resource locations of the plurality of CG resource locations in one periodicity.
      A default CG resource location in the plurality of CG resource locations is configured.
   iii. An LCP mapping relationship between a first LCH and the CG resource is configured. In at least one embodiment,
      the first LCH corresponds to an XR service; or
      the CG is associated with only the first LCH, or only the first LCH may be mapped to the CG.
   iv. The CG resource is configured through RRC re config or CG config.
   v. Activation/resuming or deactivation/suspending is configured for the CG resource.
   vi. The CG resource is of a CG Type1 and/or CG Type2.
2. The UE receives the CG resource configured by the network.
3. Based on the CG resource and/or the configuration information configured in 1) and/or the service feature such as data packet information, and/or according to a network enabling indication, use of the CG resource is determined, and/or data transmission by using the CG resource is performed, and/or reporting (such as deactivation/suspending of a CG, activation/resuming, or data rate) is performed. Specifically, at least one of the following is included.
a) The service feature may be known by the UE itself, or may be indicated by a gNB, a CN, or an application server.
b) The determining of use of the CG resource includes at least one of the following: (automatically) performing activation/resuming and/or deactivation/suspending on the CG resource.
c) The UE (automatically) performs, based on the service feature such as data packet information, and/or a network enabling indication, activation/resuming and/or deactivation/suspending on the CG resource. In at least one embodiment,
   i. if the service feature, such as data packet information, meets a first condition, and/or, based on a network enabling indication, the UE (automatically) performs activation/resuming on the CG resource.

The first condition includes at least one of the following: the data packet information is greater than or equal to a first threshold, a data packet arrives at a first time (the first time may present periodically, or may present aperiodically; the first time may be indicated by a CN or an application layer; or the first time is a time different from a second time), and the first data packet is of a specific type (for example, a full frame).

For example, when there is more data (data rate is greater than A), the UE activates/resumes a plurality of CG resources or a plurality of CG PUSCHs in one CG resource.
ii. If the service feature, such as data packet information, meets a second condition, and/or, based on a network enabling indication, the UE (automatically) performs deactivation/suspending on the CG resource.

The second condition is at least one of the following: the data packet information is less than a second threshold, a data packet arrives at a second time (the second time may present periodically, or may present aperiodically; the second time may be indicated by a CN or an application layer; or the second time is a time different from the first time), and the second data packet is of a specific type (for example, a non-full frame or a delta frame of a full frame).

For example, when there is less data (data rate is less than B), the UE reactivates/suspends a plurality of CG resources or a plurality of CG PUSCHs in one CG resource.

For example, when there is less data (data rate is less than B), the UE uses/activates/resumes only one CG resource or only one CG PUSCH in one CG resource, or uses/activates/resumes a default CG or a CG PUSCH, or uses/activates/resumes only the first CG resource in a plurality of CGs or only the first CG PUSCH in one CG resource, or uses/activates/resumes only a CG resource, in a plurality of CGs, with an index being a special value or only a CG PUSCH, in one CG resource, with an index being a special value (for example, one or more of a maximum index, a minimum index, a maximum HARQ process ID, a minimum HARQ process ID, or the like).
d) in at least one embodiment, if the deactivation/suspend of the CG resource is to be performed, the UE reports deactivation/suspend of the CG resource to the network. In at least one embodiment, at least one of the following is included.
   i. the UE reports the information by using the activated/resumed CG resource;
   ii. the UE reports the information by using another UL resource;
   iii. the UE reports the information by using UL signaling (MAC CE/UCI/RRC); or
   iv. the information includes at least one of the following: an indication for deactivating/suspending the CG resource, or a deactivated/suspended CG or CG PUSCH.
e) For the deactivated/suspended CG, in at least one embodiment:
   i. which cannot be multiplexed with UCI;
   ii. which cannot be transmitted or needs to be skipped; or
   iii. which has the lowest priority in case of resource conflict (grant or HARQ process).

Applicable scenario: The NW acquires a service feature, such as a change status of a data rate, for performing resource configuration. The UE performs, based on configuration and/or the service feature to automatically activate or deactivate a CG, to adapt to service changes. In addition, an unused resource may be used by another UE to improve system capacity.

Embodiment 4: (A network performs resource configuration or scheduling based on a service feature of a UE, such as data packet information. Configuration information varies with service feature. For example, a size of a configured resource or a quantity of configured resources, or the L1 parameter such as an MCS, or the L2 parameter such as LCH mapping varies at different periodicities, different moments, or different CG locations.) A specific implementation procedure is as follows (for example, for a case that the network knows data-packet change information and/or data-packet change information is regular):
1. The network performs resource configuration or scheduling on the UE or a service based on a service feature. In at least one embodiment, at least one of the following is included.
a) The service feature includes at least one of the following: data packet information, which is data-packet-size information, or data-volume-size information, or data rate information, or a data-packet change information/rule/periodicity.
b) The service feature corresponds to at least a first LCH.
c) The service feature is UE-specific.
d) The service is an XR service.
e) The network is a base station.
f) The network acquires the service feature based on at least one of an indication of a core network, an indication of an application layer, or reporting of the UE.
g) A CG resource is configured for the service feature. At least one of the following is included:
   i. at least one CG resource is configured, and most likely one CG resource is configured; or
   ii. the configuration information varies with the service feature, for example, a size of a configured resource or a quantity of configured resources, or an L1 parameter such as an MCS, or an L2 parameter such as LCH mapping varies at different periodicities, different moments, or different CG locations.

In at least one embodiment, the configuration information may be superimposition of a plurality of pieces of configuration information. Each configuration information is periodic or regular.

In at least one embodiment, the configuration is for an LCH/a DRB/a MAC entity/a PDCP/a UE/a CC/a CG.

In at least one embodiment, if there are a plurality of resource locations in one periodicity, resource locations of a plurality of CG resource locations are consecutive in one CG periodicity, and/or different HARQ processes are used for resource locations of the plurality of CG resource locations.

In at least one embodiment, the CG resource is configured through RRC re config or CG config.

In at least one embodiment, the CG resource is of a CG Type1 and/or CG Type2.
iii. An LCP mapping relationship between a first LCH and the CG resource is configured. In at least one embodiment,
   the first LCH corresponds to an XR service; or
   the CG is associated with only the first LCH, or only the first LCH may be mapped to the CG.
2. The UE receives the CG resource configured by the network.
3. Based on the CG resource and/or the configuration information configured in 1) and/or the service feature such as data packet information, transmission is performed by using the CG resource.

In this embodiment, the CG may alternatively be replaced with SPS.

Applicable scenario: The NW obtains a service feature, such as a data rate change, and performs resource configuration, where the resource configuration reflects a service change. An existing CG configuration manner is modified to improve system capacity.

Embodiment 5: (A network performs resource configuration or scheduling based on a service feature of a UE, such as data packet information. A corresponding service feature is configured with a plurality of sets of CG resources. In at least one embodiment, there is one CG PUSCH in each CG resource periodicity. Different CG resources are different in CG resource periodicity. A plurality of CG resources are associated with the first LCH. The plurality of CG resources are combined to meet a service transmission requirement of the first LCH or a service feature.) A specific implementation procedure is as follows (for example, for a case that the network knows data-packet change information and/or data-packet change information is regular):
1. The network performs resource configuration or scheduling on the UE or a service based on a service feature. In at least one embodiment, at least one of the following is included.
a) The service feature includes at least one of the following: data packet information, which is data-packet-size information, or data-volume-size information, or data rate information, or a data-packet change information/rule/periodicity, or a data rate change information/rule/periodicity.
b) The service feature corresponds to at least a first LCH.
c) The service feature is UE-specific.
d) The service is an XR service.
e) The network is a base station.
f) The network acquires the service feature based on at least one of an indication of a core network, an indication of an application layer, or reporting of the UE.
g) A CG resource is configured for the service feature. At least one of the following is included:
   i. a plurality of CG resources are configured;
   ii. there is one CG PUSCH in each CG resource periodicity;
   iii. different HARQ processes are used for different CG resources;
   iv. different CG resources are different in CG resource periodicity;
   v. the plurality of CG resources are combined to meet a service transmission requirement of the first LCH or a service feature;
   vi. the CG resource is configured through RRC re config or CG config;
   vii. The CG resource is of a CG Type1 and/or CG Type2; or
   viii. An LCP mapping relationship between a first LCH and the CG resource is configured. In at least one embodiment,
      the first LCH corresponds to an XR service; or
      the CG is associated with only the first LCH, or only the first LCH may be mapped to the CG.

A plurality of CG resources are associated with the first LCH. Further, the plurality of CG resources are not associated with another LCH.

The first LCH is capable of being mapped only to the plurality of CG resources.
2. The UE receives the CG resource configured by the network.
3. Based on the CG resource and/or the configuration information configured in 1), such as data packet information, transmission is performed by using the CG resource.

In this embodiment, the CG may alternatively be replaced with SPS.

Applicable scenario: The NW acquires a service feature, such as a change status of a data rate, and configures a plurality of sets of CG resources, and the plurality of sets of CG resources are combined to meet a service change. Corresponding to Embodiment 5, an existing CG configuration information is not changed.

Embodiment 6: (A network performs CG resource configuration or activation based on a service feature of a UE, such as data packet information. Specifically, more than one CG PUSCH is configured in one CG periodicity. The CG periodicity is X service periodicities or data packet periodicities). A specific implementation procedure is as follows (for UL, for a scenario such as a case that the network knows data-packet change information and/or data-packet change information is regular).
1. The network configures a CG resource or activates a configured CG resource. Specifically, the CG resource meets a service feature, such as data packet information. In at least one embodiment, at least one of the following is included.
a) The service feature includes at least one of the following: data packet information, which is data-packet-size information, or data-volume-size information, or data rate information, or a data-packet change information/rule/periodicity.
b) The service feature corresponds to at least a first LCH.
c) The service feature is UE-specific.
d) The service is an XR service.
e) The network is a base station.
f) The network acquires the service feature based on at least one of an indication of a core network, an indication of an application layer, or reporting of the UE.
g). A CG resource is configured. At least one of the following is included.
   i. One CG periodicity=X*T, where T is a service periodicity or a data packet periodicity or a data packet arrival periodicity.
   Further, X is a quantity of resources of a CG PUSCH in one CG periodicity, or X is a quantity of variable data packets, or a quantity of variable resources, or a quantity of variable data-packet-size levels, or a quantity of variable resource-size levels.
   ii. The CG periodicity includes first duration and/or second duration. The first duration is a periodicity of a service feature change or duration occupied by the service feature change. The second duration is a service periodicity or a data packet periodicity, or a data packet arrival periodicity.
   iii. There is more than one CG PUSCH or CG resource in one CG periodicity.

The plurality of CG PUSCHs or CG resources have the following features.
1) Different CG PUSCHs or CG resources correspond to different start locations in time domain.
   i. In at least one embodiment, through RRC configuration, for example, CG config, start locations (such as time domain offsets) of different CG PUSCHs or CG resources are configured or a start location (such as a time domain offset) of the first CG PUSCH or CG resource and an offset of another CG PUSCH or CG resource relative to the first CG PUSCH or CG resource are indicated.
   ii. Alternatively, in DCI, such as CG activation signaling, start locations (such as time domain offsets) of different CG PUSCHs or CG resources are indicated, or a start location (such as a time domain offset) of the first CG PUSCH or CG resource and an offset of another CG PUSCH or CG resource relative to the first CG PUSCH or CG resource are indicated.
b) In at least one embodiment, different CG PUSCHs or CG resources occupy different sizes of units (such as slot/symbol) in time domain and/or different quantities of PRBs in frequency domain.
   i. In at least one embodiment, through RRC configuration, such as CG config, sizes/lengths of time domain resources (for example, slots/symbols) and/or sizes of frequency domain resources (for example, a quantity of PRBs or frequency domain resource allocation) of different CG PUSCHs or CG resources are indicated, or a size/length of a time domain resource of the first CG PUSCH or CG resource and an offset of another CG PUSCH or CG resource relative to the first CG PUSCH or CG resource are indicated.
   ii. Alternatively, in DCI, such as CG activation DCI, sizes/lengths of time domain resources (for example, slots/symbols) and/or sizes of frequency domain resources (for example, a quantity of PRBs or frequency domain resource allocation) of different CG PUSCHs or CG resources are indicated, or a size/length of a time domain resource of the first CG PUSCH or CG resource and an offset of another CG PUSCH or CG resource relative to the first CG PUSCH or CG resource are indicated.
c) In at least one embodiment, different CG PUSCHs or CG resources use different L1 parameters such as an MCS.
   i. In at least one embodiment, through RRC configuration, for example, CG config, L1 parameters (such as MCS) of different CG PUSCHs or CG resources are configured or an L1 parameter (such as MCS) of the first CG PUSCH or CG resource and an offset of another CG PUSCH or CG resource relative to the first CG PUSCH or CG resource are indicated.
   ii. Alternatively, in DCI, such as CG activation DCI, L1 parameters (such as MCS) of different CG PUSCHs or CG resources are indicated, or an L1 parameter (such as MCS) of the first CG PUSCH or CG resource and an offset of another CG PUSCH or CG resource relative to the first CG PUSCH or CG resource are indicated.
   iv. The CG resource is of a CG Type1 and/or CG Type2.
   v. An LCP mapping relationship between a first LCH and the CG resource is configured. In at least one embodiment,
      the first LCH corresponds to an XR service; or
the CG is associated with only the first LCH, or only the first LCH may be mapped to the CG.
2. The UE receives the CG resource configured by the network and performs transmission.
3. In at least one embodiment, the network schedules retransmission of a plurality of resources by using one piece of DCI. For example, one piece of DCI indicates retransmission of a plurality of CG grants. The plurality of grants are grants for retransmission scheduling of at least one CG PUSCH in one configured CG periodicity.

In this embodiment, the CG may alternatively be replaced with SPS. This embodiment is also applicable to a case of SPS configuration (SPS is configured in this manner).

Beneficial effect: According to a service feature, a network configures a CG resource, and there are a plurality of CG PUSCHs in one CG periodicity. In addition, the network indicates, by using RRC or DCI, transmission resources (including grant and HARQ) used by different CG PUSCHs, to meet transmission of an XR service with flexible and proper resource allocation ensured.

As shown in FIG. 8, FIG. 8 is a schematic diagram of a terminal device according to an embodiment of this application, and the following components may be included.

In an embodiment of this application, a processing module 801 is configured to perform, based on at least one of configuration information, a CG resource, or a service feature, at least one of configuring of the CG resource, determining of use of the CG resource, data transmission by using the CG resource, or reporting.

In at least one embodiment, a transceiver module 802 is configured to receive CG configuration information sent by a network device, and/or a configured grant CG resource configured by the network device.

In at least one embodiment, the configuration information includes at least one of the following:
a plurality of CG resources;
one CG resource;
a mapping relationship or an association relationship between a first logical channel LCH and the CG resource, or a logical channel mapping limitation;
that the CG resource is configured by using a radio resource control reconfiguration message or through a CG configuration;
that the CG resource is used for activating/resuming, or used for deactivating/suspending;
that a type of the CG resource is CG Type1 and/or CG Type2;
a parameter corresponding to a first condition and a second condition, where the first condition and the second condition are used for activating/resuming or used for deactivating/suspending;
an enabling or activation indication corresponding to the first condition and the second condition;
an enabling or activation indication corresponding to a first case and a second case; or
an enabling or activation indication for the terminal device to perform, automatically or based on a condition, activating/resuming and/or deactivating/suspending on the CG resource.

In at least one embodiment, the configuration information includes at least one of the following:
a plurality of CG resources;
one CG resource;
a first L2 parameter;
a second L2 parameter;
a first L1 parameter;
a second L1 parameter;
a mapping relationship or an association relationship between a first logical channel LCH and the CG resource, or a logical channel mapping limitation;
that the CG resource is configured by using a radio resource control reconfiguration message or through a CG configuration;
that a type of the CG resource is CG Type1 and/or CG Type2;
a parameter corresponding to a first condition and a second condition;
an enabling or activation indication corresponding to the first condition and the second condition;
an enabling or activation indication corresponding to a first case and a second case; or
an enabling or activation indication for the terminal device to automatically perform an L1/L2 parameter change.

In at least one embodiment, in a case that the configuration information includes the plurality of CG resources, at least one of the following is included:
that each periodicity of at least one of the plurality of CG resources includes one or more CG resource locations;
that resource locations of the plurality of CG resource locations are consecutive in one time period;
that different hybrid automatic repeat request HARQ processes are used for resource locations of the plurality of CG resource locations in one time period;
a binding relationship of the plurality of CG resources; or
a default CG resource in the plurality of CG resources.

In at least one embodiment, in a case that the configuration information includes the one CG resource, at least one of the following is included:
that each periodicity of the one CG resource includes one or more CG resource locations;
that resource locations of the plurality of CG resource locations are consecutive in one periodicity;
that different hybrid automatic repeat request HARQ processes are used for resource locations of the plurality of CG resource locations in one periodicity;
a default CG resource location in the one CG resource; or
a default CG resource location in the plurality of CG resource locations.

In at least one embodiment, the configuration information is in granularity of at least one of the following: a logical channel LCH/a data radio bearer DRB/a medium access control entity MAC entity/a packet data convergence protocol PDCP/a user equipment UE/a carrier CC/a configured grant CG.

In at least one embodiment, in a case that the configuration information includes the mapping relationship or the association relationship between a first LCH and the CG resource, or the logical channel mapping limitation, at least one of the following is included:
the first LCH corresponds to an XR service;
the CG resource is associated with the first LCH, or the first LCH is capable of being mapped to the CG resource;
the CG resource is associated with only the first LCH;
the first LCH is associated with only the CG resource.

In at least one embodiment, in a case that the configuration information includes the first L2 parameter, the first L2 parameter includes a first LCH mapping relationship, and the first LCH mapping relationship includes the mapping relationship between the first LCH and the CG resource.

In at least one embodiment, at least one of the following is included:
the first LCH corresponds to an XR service;
the CG resource is associated with the first LCH, or the first LCH is capable of being mapped to the CG resource;
the CG resource is associated with only the first LCH;
the first LCH is associated with only the CG resource;
in the first case, the CG resource uses the first LCH mapping relationship; or
in the second case, a first part of the CG resource uses the first LCH mapping relationship.

In at least one embodiment, in a case that the configuration information includes the second L2 parameter, the second L2 parameter includes a second LCH mapping relationship, and the second LCH mapping relationship includes a mapping relationship between a plurality of LCHs and the CG resource.

In at least one embodiment, at least one of the following is included:
the plurality of LCHs include a first LCH;
the first LCH corresponds to an XR service;
the CG resource is associated with the first LCH, and is associated with another LCH;
the CG resource is associated with only the first LCH;
the first LCH is associated with only the CG resource;
in the second case, the CG resource uses the second LCH mapping relationship; or
in the second case, a second part of the CG resource uses the second LCH mapping relationship.

In at least one embodiment, in a case that the configuration information includes the first L1 parameter, the first L1 parameter includes an MCS parameter.

In at least one embodiment, at least one of the following is included:
in the first case, the CG resource uses the first L1 parameter; or
in the second case, a first part of the CG resource uses the first L1 parameter.

In at least one embodiment, in a case that the configuration information includes the second L1 parameter, the second L1 parameter includes an MCS parameter.

In at least one embodiment, at least one of the following is included:
in the second case, the CG resource uses the second L1 parameter; or
in the second case, a second part of the CG resource uses the second L1 parameter.

In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

In at least one embodiment, the processing module 801 is specifically configured to perform activation, resuming, deactivation, or suspending on the CG resource automatically or based on a condition.

In at least one embodiment, the processing module 801 is specifically configured to: when data packet information meets a first condition, and/or according to a first enabling or activation indication of the network device, automatically perform activation or resuming on the CG resource.

The first condition includes at least one of the following:
the data packet information is greater than or equal to a first threshold;
a data packet arrives at a first time; or
a data packet is of a first specific type.

In at least one embodiment, the processing module 801 is specifically configured to: when data packet information meets a second condition, and/or according to a second enabling or activation indication of the network device, automatically perform activation or resuming on the CG resource.

The second condition includes at least one of the following:
the data packet information is less than a second threshold;
a data packet arrives at a second time; or
a data packet is of a second specific type.

In at least one embodiment, the transceiver module 802 is further configured to report, based on the CG resource and the service feature, the data packet information or information about deactivation or suspending of the CG resource to the network device.

In at least one embodiment, the transceiver module 802 is specifically configured to report, by using an activated or resumed CG resource, the data packet information or the information about deactivation or suspending of the CG resource to the network device; or
the transceiver module 802 is specifically configured to report, by using an uplink resource, the data packet information or the information about deactivation or suspending of the CG resource to the network device; or
the transceiver module 802 is specifically configured to report, by using uplink signalling, the data packet information or the information about deactivation or suspending of the CG resource to the network device.

In at least one embodiment, the information about deactivation or suspending of the CG resource includes at least one of the following:
an indication/request for deactivating or suspending the CG resource;
data volume information currently to be transmitted; or
a to-be-deactivated or to-be-suspended CG or CG PUSCH.

In at least one embodiment, the transceiver module 802 is further configured to report the service feature or the data packet information to the network device, where the service feature or the data packet information is used for the network device to indicate that the CG resource is to be deactivated or suspended.

In at least one embodiment, the transceiver module 802 is specifically configured to perform, based on at least one of the configuration information, the CG resource, or the service feature, determining of use of the CG resource directly or automatically or based on a condition, or data transmission directly by using the CG resource.

In at least one embodiment, at least one of the following is included:
a deactivated or suspended CG is not multiplexed with UCI information, or does not carry UCI information, or fails to be multiplexed with uplink control information;
the deactivated or suspended CG is not used for transmission;
the deactivated or suspended CG is not used for transmission of a MAC CE and/or padding;
it is determined that the deactivated or suspended CG is skipped;
it is determined that the deactivated or suspended CG is a low-priority resource;
the deactivated or suspended CG is not capable of being transmitted;
transmission is performed with the deactivated or suspended CG skipped; or
the deactivated or suspended CG has the lowest priority in a case of resource conflict.

In at least one embodiment, the processing module 801 is specifically configured to perform at least one of the following:
transmission of the CG resource by using the first L1 parameter and/or the second L1 parameter; or
transmission of the CG resource by using the first L2 parameter and/or the second L2 parameter.

In at least one embodiment, the processing module 801 is specifically configured to: when data packet information meets a first condition, and/or according to a third enabling or activation indication of the network device, determine that the first case is met, or perform transmission by using the first L1 parameter/the second L1 parameter.

The first condition includes at least one of the following:
the data packet information is greater than or equal to a first threshold;
a data packet arrives at a first time; or
a data packet is of a first specific type.

In at least one embodiment, the processing module 801 is specifically configured to: when data packet information meets a second condition, and/or according to a fourth enabling or activation indication of the network device, determine that the second case is met, or perform transmission by using the second L1 parameter/the second L2 parameter, or perform transmission by using the first L1/L2 parameter and the second L1/L2 parameter.

The second condition includes at least one of the following:
the data packet information is less than a second threshold;
a data packet arrives at a second time; or
a data packet is of a second specific type.

In at least one embodiment, the transceiver module 802 is further configured to report, by the terminal device, first information to the network device, where the first information includes at least one of the following:
a service feature, a data-volume-change indication, data volume information, the data packet information, and an L1/L2 parameter to be used.

In at least one embodiment, the transceiver module 802 is specifically configured to:
report the first information to the network device by using the CG resource; or
report the first information to the network device by using an uplink resource; or
report the first information to the network device by using uplink signalling.

In at least one embodiment, the transceiver module 802 is further configured to report the service feature or the data packet information to the network device, where the service feature or the data packet information is used for the network device to indicate that an L1/L2 parameter change is to be performed.

In another embodiment of this application, the processing module 801 is configured to schedule, by using DCI according to a network device, retransmission corresponding to a plurality of first resources, where the first resource includes a CG resource and/or an SPS resource.

In at least one embodiment, at least one of the following is included:
a retransmission resource is a second resource, and the second resource is a dynamically scheduled resource;
a retransmission resource is a dynamically scheduled resource;
a retransmission resource includes a plurality of pieces of resource information;
a retransmission resource includes common information and/or different information for different SPS/CGs;
retransmission resources correspond to different SPS/CGs respectively;
a UE performs retransmission on at least one SPS/CG by using a retransmission resource; or
retransmission resources correspond to different CG PUSCHs/SPS PDSCHs of a same SPS/CG respectively.

In at least one embodiment, the CG resource or the SPS resource or both include at least one of the following:
a plurality of CG resources and/or SPS resources; or
different CG PUSCHs/SPS PDSCHs of a same SPS/CG.

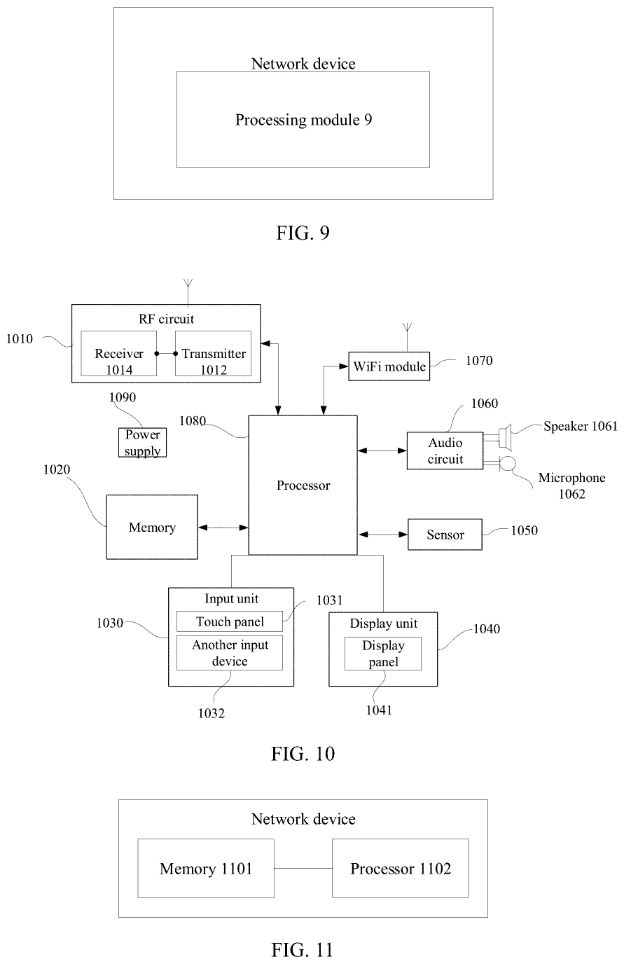

As shown in FIG. 9, FIG. 9 is a schematic diagram of a network device according to another embodiment of this application, and may include:
a processing module 901, configured to perform, based on a service feature, resource configuration or scheduling on a terminal device or a service to schedule a first resource, to obtain configuration information and/or a configured first resource, where the first resource includes a CG resource and/or an SPS resource.

In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

In at least one embodiment, the service feature is obtained through at least one of an indication of a core network device, an indication of an application layer, or reporting of the terminal device.

In at least one embodiment, the service feature corresponds to at least a first LCH; or
the service feature is specific for the terminal device; or
the service is an XR service; or
the network device is a base station.

In at least one embodiment, the first resource includes the CG resource, and the configuration information includes at least one of the following:
a plurality of CG resources;
one CG resource;
a mapping relationship or an association relationship between a first logical channel LCH and the CG resource, or a logical channel mapping limitation;
that the CG resource is configured by using a radio resource control reconfiguration message or through a CG configuration;
that the CG resource is used for activating/resuming, or used for deactivating/suspending;
that a type of the CG resource is CG Type1 and/or CG Type2;
a parameter corresponding to a first condition and a second condition, where the first condition and the second condition are used for activating/resuming or used for deactivating/suspending;
an enabling or activation indication corresponding to the first condition and the second condition;
an enabling or activation indication corresponding to a first case and a second case; or
an enabling or activation indication for the terminal device to perform, automatically or based on a condition, activating/resuming and/or deactivating/suspending on the first resource.

In at least one embodiment, the first resource includes the CG resource and/or the SPS resource, and the configuration information includes at least one of the following:
a plurality of first resources;
one first resource;
a mapping relationship or an association relationship between a first logical channel LCH and the first resource, or a logical channel mapping limitation;
that the first resource is configured by using a radio resource control reconfiguration message or through a first configuration; or
that a type of the CG resource is CG Type1 and/or CG Type2 in a case that the first resource includes the CG resource.

In at least one embodiment, in a case that the configuration information includes the plurality of first resources, at least one of the following is included:
that each periodicity of each of the plurality of first resources includes one or more first resource locations;
that resource locations of the plurality of first resource locations are consecutive in one time period;
that different hybrid automatic repeat request HARQ processes are used for resource locations of the plurality of first resource locations in one time period;
a binding relationship of the plurality of first resources; or
a default first resource in the plurality of first resources.

In at least one embodiment, in a case that the configuration information includes the one first resource, at least one of the following is included:
that each periodicity of the one first resource includes one or more first resource locations;
that resource locations of the plurality of first resource locations are consecutive in one periodicity;
that different hybrid automatic repeat request HARQ processes are used for resource locations of the plurality of first resource locations in one periodicity; or
a default first resource location in the plurality of first resource locations.

In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or
the first LCH is associated with only the first resource.

In at least one embodiment, the configuration information is in granularity of at least one of the following: an LCH/a DRB/a MAC entity/a PDCP/a UE/a CC/a CG/SPS.

In at least one embodiment, the first resource includes the CG resource and/or the SPS resource, and the service feature corresponds to different configuration information.

In at least one embodiment, sizes of the first resource, L1 parameters, or L2 parameters configured at different periodicities/different moments/different first locations are different.

In at least one embodiment, the configuration information is a superposition of a plurality of pieces of configuration information, and each of the plurality of pieces of configuration information is periodic or regular.

In at least one embodiment, the first resource includes the CG resource and/or the SPS resource, and the configuration information includes at least one of the following:
a plurality of first resources;
that there is one CG PUSCH or SPS PUSCH in each first resource periodicity;
a mapping relationship or an association relationship between a first logical channel LCH and the first resource, or a logical channel mapping limitation;
that different HARQ processes are used for different first resources;
that different first resources are different in first resource periodicity;
that the plurality of first resources are combined to meet a service transmission requirement of a first LCH or the service feature;
that the first resource is configured by using a radio resource control reconfiguration message or through a first configuration; or
that a type of the CG resource is CG Type1 and/or CG Type2 in a case that the first resource includes the CG resource.

In at least one embodiment, in a case that the configuration information includes the mapping relationship or the association relationship between a first logical channel LCH and the first resource, or the logical channel mapping limitation, at least one of the following is included:
the first LCH corresponds to an XR service;
the first resource is associated with the first LCH;
the first LCH is capable of being mapped to the first resource;
the plurality of first resources are associated with the first LCH;
the plurality of first resources are associated with the first LCH, and are not associated with another LCH;
the first resource is associated with only the first LCH; or
the first LCH is associated with only the first resource.

In at least one embodiment, the first resource includes the CG resource and/or the SPS resource, and the configuration information includes at least one of the following:
that a first periodicity includes a periodicity of a service feature change or an integer multiple of T, where T is a service periodicity or a data packet periodicity, or a data packet arrival periodicity;
that the first periodicity includes first duration and/or second duration, the first duration is the periodicity of the service feature change or duration occupied by the service feature change, and the second duration is a service periodicity or a data packet periodicity, or the data packet arrival periodicity;
a plurality of CG PUSCHs or SPS PUSCHs or first resources in the one first periodicity;
an LCP relationship between a first LCH and the first resource; or
that a type of the CG resource is CG Type1 and/or CG Type2 in a case that the first resource includes the CG resource.

In at least one embodiment, the first periodicity is a CG periodicity or an SPS periodicity.

In at least one embodiment, the first periodicity is a product of X and T, and X is a quantity of resources of a CG PUSCH in one CG periodicity, or a quantity of variable data packets, or a quantity of variable resources, or a quantity of variable data-packet-size levels, or a quantity of variable resource-size levels; or X is a quantity of resources of an SPS PUSCH in one SPS periodicity, or a quantity of variable data packets, or a quantity of variable resources, or a quantity of variable data-packet-size levels, or a quantity of variable resource-size levels.

In at least one embodiment, in a case that the configuration information includes the plurality of CG PUSCHs or the SPS PUSCHs or first resource, at least one of the following is included:
different CG PUSCHs or SPS PUSCHs or first resources correspond to different start locations in time domain;
different CG PUSCHs or SPS PUSCHs or first resources occupy different sizes of units in time domain, and/or occupy different quantities of resources in frequency domain;
different CG PUSCHs or SPS PUSCHs or first resources use different L1 parameters; or
different CG PUSCHs or SPS PUSCHs or first resources use different L2 parameters.

In at least one embodiment, the start location in time domain is as follows:
locations, configured through radio resource control RRC or indicated by downlink control information DCI, of different CG PUSCHs or SPS PUSCHs or the first resources; or
a location, configured through RRC or indicated in DCI, of a specific CG PUSCH or a specific SPS PUSCH or the first resource; or
a start location, configured through the RRC or indicated in the DCI, of the first CG PUSCH or the first SPS PUSCH or the first resource, and an offset, configured through the RRC or indicated in the DCI, of another CG PUSCH or another SPS PUSCH or the first resource relative to the first CG PUSCH or the first SPS PUSCH or the first resource; or
a start location, configured through the RRC or indicated in the DCI, of a specific CG PUSCH or a specific SPS PUSCH or the first resource, and an offset, configured through the RRC or indicated in the DCI, of another CG PUSCH or another SPS PUSCH or the first resource relative to the specific CG PUSCH or the specific SPS PUSCH or the first resource.

In at least one embodiment, the sizes of units in time domain and/or the quantities of resources in frequency domain and/or a location in frequency domain are as follows:
sizes in time domain, and/or quantities in frequency domain, and/or locations in frequency domain, configured through RRC or indicated in DCI, of different CG PUSCHs or SPS PUSCHs or the first resources; or
a size in time domain, and/or a quantity in frequency domain, and/or a location in frequency domain, configured through RRC or indicated in DCI, of a specific CG PUSCH or a specific SPS PUSCH or the first resource; or
a size in time domain, and/or a quantity in frequency domain, and/or a location in frequency domain, configured through the RRC or indicated in the DCI, of the first CG PUSCH or the first SPS PUSCH or the first resource, and an offset of another CG PUSCH or another SPS PUSCH or the first resource relative to the first CG PUSCH or the first SPS PUSCH or the first resource; or
a size in time domain, and/or a quantity in frequency domain, and/or a location in frequency domain, configured through the RRC or indicated in the DCI, of a specific CG PUSCH or a specific SPS PUSCH or the first resource, and an offset of another CG PUSCH or another SPS PUSCH or the first resource relative to the specific CG PUSCH or the specific SPS PUSCH or the first resource.

In at least one embodiment, the L1 parameter is as follows:
L1 parameters, configured through RRC or indicated in DCI, of different CG PUSCHs or different SPS PUSCHs or the first resource; or
an L1 parameter, configured through RRC or indicated in DCI, of a specific CG PUSCH or a specific SPS PUSCH or the first resource; or
an L1 parameter, configured through the RRC or indicated in the DCI, of the first CG PUSCH or the first SPS PUSCH or the first resource, and an offset of another CG PUSCH or another SPS PUSCH or the first resource relative to the first CG PUSCH or the first SPS PUSCH or the first resource; or
an L1 parameter, configured through the RRC or indicated in the DCI, of a specific CG PUSCH or a specific SPS PUSCH or the first resource, and an offset of another CG PUSCH or another SPS PUSCH or the first resource relative to the specific CG PUSCH or the specific SPS PUSCH or the first resource.

In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or
the first LCH is associated with only the first resource.

In at least one embodiment, the processing module 901 is further configured to schedule, by using DCI, retransmission of a plurality of CG resources or SPS resources.

In at least one embodiment, the plurality of CG resources are a grant for retransmission scheduling of at least one of the plurality of CG PUSCHs configured in one CG periodicity.

The plurality of SPS resources are a grant for retransmission scheduling of at least one of the plurality of SPS PUSCHs configured in one SPS periodicity.

In at least one embodiment, the processing module 901 is further adapted to configure or schedule a first resource or a resource location that is not used by the terminal device for another terminal device; or
the processing module 901 is further adapted to: at a first resource or a resource location that is not used by the terminal device, schedule another UE to perform transmission, or allocate a transmission resource for another UE.

In at least one embodiment, at least one of the configuration information, the CG resource, or a service feature is used to perform at least one of configuring of the CG resource, determining of use of the CG resource, data transmission by using the CG resource, or reporting.

In at least one embodiment, at least one of the configuration information, the CG resource, or a service feature is used for determining use of the CG resource directly/automatically/based on a condition, or performing data transmission by using the CG resource directly/automatically/based on a condition.

As shown in FIG. 10, FIG. 10 is a schematic diagram of a terminal device according to another embodiment of this application, and the following components may be included.

An example in which the terminal device is a mobile phone is used for description. The mobile phone may include components such as a radio frequency (RF) circuit 1010, a memory 1020, an input unit 1030, a display unit 1040, a sensor 1050, an audio circuit 1060, a wireless fidelity (WiFi) module 1070, a processor 1080, and a power supply 1090. The radio frequency circuit 1010 includes a receiver 1014 and a transmitter 1012. A person skilled in the art may understand that a mobile phone structure shown in FIG. 10 does not constitute any limitation on the mobile phone. The mobile phone may include more or fewer components than those shown in the figure, or some components may be combined, or there may be a different component arrangement.

The following specifically describes each component of the mobile phone with reference to FIG. 10.

The RF circuit 1010 may be configured to: receive and send information, or perform signal reception and transmission in a call process, and specifically, receive downlink information of a base station for processing by the processor 1080; and also transmit uplink data to the base station. Generally, the RF circuit 1010 includes but is not limited to an antenna, at least one amplifier, a transceiver, a coupler, a low noise amplifier (LNA), a duplexer, and the like. In addition, the RF circuit 1010 may further communicate with a network and another device through wireless communication. The foregoing wireless communication may use any communications standard or protocol, including but not limited to a global system of mobile communication (GSM), a general packet radio service (GPRS), code division multiple access (CDMA), wideband code division multiple access (WCDMA), long term evolution (LTE), e-mail, short messaging service (SMS), and the like.

The memory 1020 may be configured to store a software program and a module. The processor 1080 executes various functional applications and data processing of the mobile phone by running the software program and the module that are stored in the memory 1020. The memory 1020 may mainly include a program storage area and a data storage area. The program storage area may be used to store an operating system, an application program required for at least one function (such as a sound play function and an image play function), and the like. The data storage area may be used to store data (such as audio data and a phone book) created based on use of the mobile phone, and the like. In addition, the memory 1020 may include a high-speed random access memory, and may further include a non-volatile memory such as at least one magnetic disk storage device, a flash memory device, or another volatile solid-state storage device.

The input unit 1030 may be configured to receive input digit or character information, and generate key signal input that is related to user setting and function control of the mobile phone. Specifically, the input unit 1030 may include a touch panel 1031 and another input device 1032. The touch panel 1031, also referred to as a touchscreen, may collect a touch operation performed by a user on or near the touch panel 1031 (for example, an operation performed by the user on or near the touch panel 1031 by using any suitable object or accessory such as a finger or a stylus), and drive a corresponding connection apparatus according to a preset program. In at least one embodiment, the touch panel 1031 may include two parts: a touch detection apparatus and a touch controller. The touch detection apparatus detects a touch direction of the user, detects a signal caused by a touch operation, and transmits the signal to the touch controller. The touch controller receives touch information from the touch detection apparatus, converts the touch information to point coordinates, then sends the point coordinates to the processor 1080, and can receive and execute a command sent by the processor 1080. In addition, the touch panel 1031 may be implemented in a plurality of forms, for example, as a resistive, capacitive, infrared, or surface acoustic wave touch panel. In addition to the touch panel 1031, the input unit 1030 may further include another input device 1032. Specifically, the another input device 1032 may include but is not limited to one or more of a physical keyboard, a function key (such as a volume control key or a switch key), a trackball, a mouse, an operating lever, or the like.

The display unit 1040 may be configured to display information entered by the user or information provided to the user, and various menus of the mobile phone. The display unit 1040 may include a display panel 1041, and in at least one embodiment, the display panel 1041 may be configured in a form of liquid crystal display (LCD), organic light-emitting diode (OLED), or the like. Further, the touch panel 1031 may cover the display panel 1041. After detecting a touch operation on or near the touch panel 1031, the touch panel 1031 transmits the touch operation to the processor 1080 to determine a type of a touch event. Then the processor 1080 provides corresponding visual output on the display panel 1041 based on the type of the touch event. In FIG. 10, the touch panel 1031 and the display panel 1041 are used as two independent parts to implement input and input functions of the mobile phone. However, in some embodiments, the touch panel 1031 and the display panel 1041 may be integrated to implement input and output functions of the mobile phone.

The mobile phone may further include at least one sensor 1050, such as a light sensor, a motion sensor, and another sensor. Specifically, the light sensor may include an ambient light sensor and a proximity sensor. The ambient light sensor may adjust brightness of a display panel 1041 based on brightness of ambient light, and the proximity sensor may turn off the display panel 1041 and/or backlight when the mobile phone is moved towards the ear. As a motion sensor, an accelerometer sensor may detect a magnitude of acceleration in each direction (generally three axes), and may detect a magnitude and a direction of gravity at rest. The accelerometer sensor may be configured to identify an application of a mobile phone attitude (for example, a switch between a horizontal screen and a vertical screen, a related game, magnetometer attitude calibration), and a vibration recognition related function (for example, a pacemaker or tapping). Other sensors such as a gyroscope, a barometer, a hygrometer, a thermometer, and an infrared sensor that may be further configured on the mobile phone are not described herein.

The audio circuit 1060, a speaker 1061, and a microphone 1062 may provide an audio interface between a user and the mobile phone. The audio circuit 1060 may transmit an electrical signal converted from the received audio data to the speaker 1061, and the speaker 1061 converts the electrical signal into an audio signal for output. On the other hand, the microphone 1062 converts the collected audio signal into an electrical signal, the electrical signal is received by the audio circuit 1060 and then is converted into audio data, and then the audio data is output for processing by the processor 1080. The processed audio data is sent by the RF circuit 1010 to another mobile phone, or the audio data is output to the memory 1020 for further processing.

WiFi belongs to a short-distance wireless transmission technology. The mobile phone may help the user to send and receive E-mail, browse a web page, access streaming media, and the like by using the WiFi module 1070. The WiFi module provides the user with wireless broadband Internet access. Although FIG. 10 shows the WiFi module 1070, it may be understood that the WiFi module 1070 is not a mandatory component of a mobile phone, and may be omitted according to a requirement without changing the essence of this application.

The processor 1080 is a control center of the mobile phone, is connected to various parts of the entire mobile phone by using various interfaces and lines, and performs various functions and processing data of the mobile phone by running or executing a software program and/or a module stored in the memory 1020 and invoking data stored in the memory 1020, so as to perform overall monitoring on the mobile phone. In at least one embodiment, the processor 1080 may include one or more processing units. In an embodiment, the processor 1080 may integrate an application processor and a modem processor. The application processor mainly processes an operating system, a user interface, an application program, and the like. The modem processor mainly processes wireless communication. It may be understood that the modem processor may alternatively not be integrated into the processor 1080.

The mobile phone further includes a power supply 1090 (for example, a battery) that supplies power to the components. In an embodiment, the power supply may be logically connected to the processor 1080 by using a power management system, so as to implement functions such as charging management, discharging management, and power consumption management by using the power management system. Although not shown, the mobile phone may further include a camera, a Bluetooth module, and the like. Details are not described herein again.

In an embodiment of this application, the processor 1080 is configured to perform, based on at least one of configuration information, a CG resource, or a service feature, at least one of configuring of the CG resource, determining of use of the CG resource, data transmission by using the CG resource, or reporting.

In at least one embodiment, the RF circuit 1010 is configured to receive CG configuration information sent by a network device, and/or a configured grant CG resource configured by the network device.

In at least one embodiment, the configuration information includes at least one of the following:
a plurality of CG resources;
one CG resource;
a mapping relationship or an association relationship between a first logical channel LCH and the CG resource, or a logical channel mapping limitation;
that the CG resource is configured by using a radio resource control reconfiguration message or through a CG configuration;
that the CG resource is used for activating/resuming, or used for deactivating/suspending;
that a type of the CG resource is CG Type1 and/or CG Type2;
a parameter corresponding to a first condition and a second condition, where the first condition and the second condition are used for activating/resuming or used for deactivating/suspending;
an enabling or activation indication corresponding to the first condition and the second condition;
an enabling or activation indication corresponding to a first case and a second case; or
an enabling or activation indication for the terminal device to perform, automatically or based on a condition, activating/resuming and/or deactivating/suspending on the CG resource.

In at least one embodiment, the configuration information includes at least one of the following:
a plurality of CG resources;
one CG resource;
a first L2 parameter;
a second L2 parameter;
a first L1 parameter;
a second L1 parameter;
a mapping relationship or an association relationship between a first logical channel LCH and the CG resource, or a logical channel mapping limitation;
that the CG resource is configured by using a radio resource control reconfiguration message or through a CG configuration;
that a type of the CG resource is CG Type1 and/or CG Type2;
a parameter corresponding to a first condition and a second condition;
an enabling or activation indication corresponding to the first condition and the second condition;
an enabling or activation indication corresponding to a first case and a second case; or
an enabling or activation indication for the terminal device to automatically perform an L1/L2 parameter change.

In at least one embodiment, in a case that the configuration information includes the plurality of CG resources, at least one of the following is included:
that each periodicity of at least one of the plurality of CG resources includes one or more CG resource locations;
that resource locations of the plurality of CG resource locations are consecutive in one time period;
that different hybrid automatic repeat request HARQ processes are used for resource locations of the plurality of CG resource locations in one time period;
a binding relationship of the plurality of CG resources; or
a default CG resource in the plurality of CG resources.

In at least one embodiment, in a case that the configuration information includes the one CG resource, at least one of the following is included:
that each periodicity of the one CG resource includes one or more CG resource locations;
that resource locations of the plurality of CG resource locations are consecutive in one periodicity;
that different hybrid automatic repeat request HARQ processes are used for resource locations of the plurality of CG resource locations in one periodicity;
a default CG resource location in the one CG resource; or
a default CG resource location in the plurality of CG resource locations.

In at least one embodiment, the configuration information is in granularity of at least one of the following: a logical channel LCH/a data radio bearer DRB/a medium access control entity MAC entity/a packet data convergence protocol PDCP/a user equipment UE/a carrier CC/a configured grant CG.

In at least one embodiment, in a case that the configuration information includes the mapping relationship or the association relationship between a first LCH and the CG resource, or the logical channel mapping limitation, at least one of the following is included:
the first LCH corresponds to an XR service;
the CG resource is associated with the first LCH, or the first LCH is capable of being mapped to the CG resource;
the CG resource is associated with only the first LCH; or
the first LCH is associated with only the CG resource.

In at least one embodiment, in a case that the configuration information includes the first L2 parameter, the first L2 parameter includes a first LCH mapping relationship, and the first LCH mapping relationship includes the mapping relationship between the first LCH and the CG resource.

In at least one embodiment, at least one of the following is included:
the first LCH corresponds to an XR service;
the CG resource is associated with the first LCH, or the first LCH is capable of being mapped to the CG resource;
the CG resource is associated with only the first LCH; or
the first LCH is associated with only the CG resource;
in the first case, the CG resource uses the first LCH mapping relationship; or
in the second case, a first part of the CG resource uses the first LCH mapping relationship.

In at least one embodiment, in a case that the configuration information includes the second L2 parameter, the second L2 parameter includes a second LCH mapping relationship, and the second LCH mapping relationship includes a mapping relationship between a plurality of LCHs and the CG resource.

In at least one embodiment, at least one of the following is included:
the plurality of LCHs include a first LCH;
the first LCH corresponds to an XR service;
the CG resource is associated with the first LCH, and is associated with another LCH;
the CG resource is associated with only the first LCH;
the first LCH is associated with only the CG resource;
in the second case, the CG resource uses the second LCH mapping relationship; or
in the second case, a second part of the CG resource uses the second LCH mapping relationship.

In at least one embodiment, in a case that the configuration information includes the first L1 parameter, the first L1 parameter includes an MCS parameter.

In at least one embodiment, at least one of the following is included:
in the first case, the CG resource uses the first L1 parameter; or
in the second case, a first part of the CG resource uses the first L1 parameter.

In at least one embodiment, in a case that the configuration information includes the second L1 parameter, the second L1 parameter includes an MCS parameter.

In at least one embodiment, at least one of the following is included:
in the second case, the CG resource uses the second L1 parameter; or
in the second case, a second part of the CG resource uses the second L1 parameter.

In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

In at least one embodiment, the processor 1080 is specifically configured to perform activation, resuming, deactivation, or suspending on the CG resource automatically or based on a condition.

In at least one embodiment, the processor 1080 is specifically configured to: when data packet information meets a first condition, and/or according to a first enabling or activation indication of the network device, automatically perform activation or resuming on the CG resource.

The first condition includes at least one of the following:
the data packet information is greater than or equal to a first threshold;
a data packet arrives at a first time; or
a data packet is of a first specific type.

In at least one embodiment, the processor 1080 is specifically configured to: when data packet information meets a second condition, and/or according to a second enabling or activation indication of the network device, automatically perform activation or resuming on the CG resource.

The second condition includes at least one of the following:
the data packet information is less than a second threshold;
a data packet arrives at a second time; or
a data packet is of a second specific type.

In at least one embodiment, the RF circuit 1010 is further configured to report, based on the CG resource and the service feature, the data packet information or information about deactivation or suspending of the CG resource to the network device.

In at least one embodiment, the RF circuit 1010 is specifically configured to report, by using an activated or resumed CG resource, the data packet information or the information about deactivation or suspending of the CG resource to the network device; or

The RF circuit 1010 is specifically configured to report, by using an uplink resource, the data packet information or the information about deactivation or suspending of the CG resource to the network device; or

The RF circuit 1010 is specifically configured to report, by using uplink signalling, the data packet information or the information about deactivation or suspending of the CG resource to the network device.

In at least one embodiment, the information about deactivation or suspending of the CG resource includes at least one of the following:
an indication/request for deactivating or suspending the CG resource;
data volume information currently to be transmitted; or
a to-be-deactivated or to-be-suspended CG or CG PUSCH.

In at least one embodiment, the RF circuit 1010 is further configured to report the service feature or the data packet information to the network device, where the service feature or the data packet information is used for the network device to indicate that the CG resource is to be deactivated or suspended.

In at least one embodiment, the RF circuit 1010 is specifically configured to perform, based on at least one of the configuration information, the CG resource, or the service feature, determining of use of the CG resource directly or automatically or based on a condition, or data transmission directly by using the CG resource.

In at least one embodiment, at least one of the following is included:
a deactivated or suspended CG is not multiplexed with UCI information, or does not carry UCI information, or fails to be multiplexed with uplink control information;
the deactivated or suspended CG is not used for transmission;
the deactivated or suspended CG is not used for transmission of a MAC CE and/or padding;
it is determined that the deactivated or suspended CG is skipped;
it is determined that the deactivated or suspended CG is a low-priority resource;
the deactivated or suspended CG is not capable of being transmitted;
transmission is performed with the deactivated or suspended CG skipped; or
the deactivated or suspended CG has the lowest priority in a case of resource conflict.

In at least one embodiment, the processor 1080 is specifically configured to perform at least one of the following:
transmission of the CG resource by using the first L1 parameter and/or the second L1 parameter; or
transmission of the CG resource by using the first L2 parameter and/or the second L2 parameter.

In at least one embodiment, the processor 1080 is specifically configured to: when data packet information meets a first condition, and/or according to a third enabling or activation indication of the network device, determine that the first case is met, or perform transmission by using the first L1 parameter/the second L1 parameter.

The first condition includes at least one of the following:
the data packet information is greater than or equal to a first threshold;
a data packet arrives at a first time; or
a data packet is of a first specific type.

In at least one embodiment, the processor 1080 is specifically configured to: when data packet information meets a second condition, and/or according to a fourth enabling or activation indication of the network device, determine that the second case is met, or perform transmission by using the second L1 parameter/the second L2 parameter, or perform transmission by using the first L1/L2 parameter and the second L1/L2 parameter.

The second condition includes at least one of the following:
the data packet information is less than a second threshold;
a data packet arrives at a second time; or
a data packet is of a second specific type.

In at least one embodiment, the RF circuit 1010 is further configured to report, by the terminal device, first information to the network device, where the first information includes at least one of the following:
a service feature, a data-volume-change indication, data volume information, the data packet information, and an L1/L2 parameter to be used.

In at least one embodiment, the RF circuit 1010 is specifically configured to:
report the first information to the network device by using the CG resource; or
report the first information to the network device by using an uplink resource; or
report the first information to the network device by using uplink signalling.

In at least one embodiment, the RF circuit 1010 is further configured to report the service feature or the data packet information to the network device, where the service feature or the data packet information is used for the network device to indicate that an L1/L2 parameter change is to be performed.

In another embodiment of this application, the processor 1080 is configured to schedule, by using DCI according to a network device, retransmission corresponding to a plurality of first resources, where the first resource includes a CG resource and/or an SPS resource.

In at least one embodiment, at least one of the following is included:
a retransmission resource is a second resource, and the second resource is a dynamically scheduled resource;
a retransmission resource is a dynamically scheduled resource;
a retransmission resource includes a plurality of pieces of resource information;
a retransmission resource includes common information and/or different information for different SPS/CGs;
retransmission resources correspond to different SPS/CGs respectively;
a UE performs retransmission on at least one SPS/CG by using a retransmission resource; or
retransmission resources correspond to different CG PUSCHs/SPS PDSCHs of a same SPS/CG respectively.

In at least one embodiment, the CG resource or the SPS resource or both include at least one of the following:
a plurality of CG resources and/or SPS resources; or
different CG PUSCHs/SPS PDSCHs of a same SPS/CG.

As shown in FIG. 11, FIG. 11 is a schematic diagram of a network device according to another embodiment of this application, and may include:
a memory 1101 storing executable program codes; and
a processor 1102 coupled to the memory 1101, where
the processor 1102 is configured to perform, based on a service feature, resource configuration or scheduling on a terminal device or a service to schedule a first resource, to obtain configuration information and/or a configured first resource, where the first resource includes a CG resource and/or an SPS resource.

In at least one embodiment, the service feature includes at least one of data packet information, data volume information, or data rate information.

In at least one embodiment, the data packet information includes at least one of the following: data-packet-size information, a data-packet-size change status, a data-packet-size change rule, a data-packet change periodicity, or a data-packet-size change start location/offset.

The data volume information includes at least one of the following: data-volume-size information, a data-volume-size change status, a data-volume-size change rule, a data-volume change periodicity, or a data-volume change start location/offset.

The data rate information includes at least one of the following: data-rate-amplitude information, a data-rate change status, a data-rate change rule, a data-rate change periodicity, or a data-rate change start location/offset.

In at least one embodiment, the service feature is obtained through at least one of an indication of a core network device, an indication of an application layer, or reporting of the terminal device.

In at least one embodiment, the service feature corresponds to at least a first LCH; or
the service feature is specific for the terminal device; or
the service is an XR service; or
the network device is a base station.

In at least one embodiment, the first resource includes the CG resource, and the configuration information includes at least one of the following:
a plurality of CG resources;
one CG resource;
a mapping relationship or an association relationship between a first logical channel LCH and the CG resource, or a logical channel mapping limitation;
that the CG resource is configured by using a radio resource control reconfiguration message or through a CG configuration;
that the CG resource is used for activating/resuming, or used for deactivating/suspending;
that a type of the CG resource is CG Type1 and/or CG Type2;
a parameter corresponding to a first condition and a second condition, where the first condition and the second condition are used for activating/resuming or used for deactivating/suspending;
an enabling or activation indication corresponding to the first condition and the second condition;
an enabling or activation indication corresponding to a first case and a second case; or
an enabling or activation indication for the terminal device to perform, automatically or based on a condition, activating/resuming and/or deactivating/suspending on the first resource.

In at least one embodiment, the first resource includes the CG resource and/or the SPS resource, and the configuration information includes at least one of the following:
a plurality of first resources;
one first resource;
a mapping relationship or an association relationship between a first logical channel LCH and the first resource, or a logical channel mapping limitation;
that the first resource is configured by using a radio resource control reconfiguration message or through a first configuration; or
that a type of the CG resource is CG Type1 and/or CG Type2 in a case that the first resource includes the CG resource.

In at least one embodiment, in a case that the configuration information includes the plurality of first resources, at least one of the following is included:
that each periodicity of each of the plurality of first resources includes one or more first resource locations;
that resource locations of the plurality of first resource locations are consecutive in one time period;
that different hybrid automatic repeat request HARQ processes are used for resource locations of the plurality of first resource locations in one time period;
a binding relationship of the plurality of first resources; or
a default first resource in the plurality of first resources.

In at least one embodiment, in a case that the configuration information includes the one first resource, at least one of the following is included:
that each periodicity of the one first resource includes one or more first resource locations;
that resource locations of the plurality of first resource locations are consecutive in one periodicity;
that different hybrid automatic repeat request HARQ processes are used for resource locations of the plurality of first resource locations in one periodicity; or
a default first resource location in the plurality of first resource locations.

In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or
the first LCH is associated with only the first resource.

In at least one embodiment, the configuration information is in granularity of at least one of the following: an LCH/a DRB/a MAC entity/a PDCP/a UE/a CC/a CG/SPS.

In at least one embodiment, the first resource includes the CG resource and/or the SPS resource, and the service feature corresponds to different configuration information.

In at least one embodiment, sizes of the first resource, L1 parameters, or L2 parameters configured at different periodicities/different moments/different first locations are different.

In at least one embodiment, the configuration information is a superposition of a plurality of pieces of configuration information, and each of the plurality of pieces of configuration information is periodic or regular.

In at least one embodiment, the first resource includes the CG resource and/or the SPS resource, and the configuration information includes at least one of the following:
a plurality of first resources;
that there is one CG PUSCH or SPS PUSCH in each first resource periodicity;
a mapping relationship or an association relationship between a first logical channel LCH and the first resource, or a logical channel mapping limitation;
that different HARQ processes are used for different first resources;
that different first resources are different in first resource periodicity;
that the plurality of first resources are combined to meet a service transmission requirement of a first LCH or the service feature;
that the first resource is configured by using a radio resource control reconfiguration message or through a first configuration; or
that a type of the CG resource is CG Type1 and/or CG Type2 in a case that the first resource includes the CG resource.

In at least one embodiment, in a case that the configuration information includes the mapping relationship or the association relationship between a first logical channel LCH and the first resource, or the logical channel mapping limitation, at least one of the following is included:
the first LCH corresponds to an XR service;
the first resource is associated with the first LCH;
the first LCH is capable of being mapped to the first resource;
the plurality of first resources are associated with the first LCH;
the plurality of first resources are associated with the first LCH, and are not associated with another LCH;
the first resource is associated with only the first LCH; or
the first LCH is associated with only the first resource.

In at least one embodiment, the first resource includes the CG resource and/or the SPS resource, and the configuration information includes at least one of the following:
that a first periodicity includes a periodicity of a service feature change or an integer multiple of T, where T is a service periodicity or a data packet periodicity, or a data packet arrival periodicity;
that the first periodicity includes first duration and/or second duration, the first duration is the periodicity of the service feature change or duration occupied by the service feature change, and the second duration is a service periodicity or a data packet periodicity, or the data packet arrival periodicity;
a plurality of CG PUSCHs or SPS PUSCHs or first resources in the one first periodicity;
   an LCP relationship between a first LCH and the first resource; or
that a type of the CG resource is CG Type1 and/or CG Type2 in a case that the first resource includes the CG resource.

In at least one embodiment, the first periodicity is a CG periodicity or an SPS periodicity.

In at least one embodiment, the first periodicity is a product of X and T, and X is a quantity of resources of a CG PUSCH in one CG periodicity, or a quantity of variable data packets, or a quantity of variable resources, or a quantity of variable data-packet-size levels, or a quantity of variable resource-size levels; or X is a quantity of resources of an SPS PUSCH in one SPS periodicity, or a quantity of variable data packets, or a quantity of variable resources, or a quantity of variable data-packet-size levels, or a quantity of variable resource-size levels.

In at least one embodiment, in a case that the configuration information includes the plurality of CG PUSCHs or the SPS PUSCHs or first resource, at least one of the following is included:
different CG PUSCHs or SPS PUSCHs or first resources correspond to different start locations in time domain;
different CG PUSCHs or SPS PUSCHs or first resources occupy different sizes of units in time domain, and/or occupy different quantities of resources in frequency domain;
different CG PUSCHs or SPS PUSCHs or first resources use different L1 parameters; or
different CG PUSCHs or SPS PUSCHs or first resources use different L2 parameters.

In at least one embodiment, the start location in time domain is as follows:
locations, configured through radio resource control RRC or indicated by downlink control information DCI, of different CG PUSCHs or SPS PUSCHs or the first resources; or
a location, configured through RRC or indicated in DCI, of a specific CG PUSCH or a specific SPS PUSCH or the first resource; or
a start location, configured through the RRC or indicated in the DCI, of the first CG PUSCH or the first SPS PUSCH or the first resource, and an offset, configured through the RRC or indicated in the DCI, of another CG PUSCH or another SPS PUSCH or the first resource relative to the first CG PUSCH or the first SPS PUSCH or the first resource; or
a start location, configured through the RRC or indicated in the DCI, of a specific CG PUSCH or a specific SPS PUSCH or the first resource, and an offset, configured through the RRC or indicated in the DCI, of another CG PUSCH or another SPS PUSCH or the first resource relative to the specific CG PUSCH or the specific SPS PUSCH or the first resource.

In at least one embodiment, the sizes of units in time domain and/or the quantities of resources in frequency domain and/or a location in frequency domain are as follows:
sizes in time domain, and/or quantities in frequency domain, and/or locations in frequency domain, configured through RRC or indicated in DCI, of different CG PUSCHs or SPS PUSCHs or the first resources; or
a size in time domain, and/or a quantity in frequency domain, and/or a location in frequency domain, configured through RRC or indicated in DCI, of a specific CG PUSCH or a specific SPS PUSCH or the first resource; or
a size in time domain, and/or a quantity in frequency domain, and/or a location in frequency domain, configured through the RRC or indicated in the DCI, of the first CG PUSCH or the first SPS PUSCH or the first resource, and an offset of another CG PUSCH or another SPS PUSCH or the first resource relative to the first CG PUSCH or the first SPS PUSCH or the first resource; or
a size in time domain, and/or a quantity in frequency domain, and/or a location in frequency domain, configured through the RRC or indicated in the DCI, of a specific CG PUSCH or a specific SPS PUSCH or the first resource, and an offset of another CG PUSCH or another SPS PUSCH or the first resource relative to the specific CG PUSCH or the specific SPS PUSCH or the first resource.

In at least one embodiment, the L1 parameter is as follows:
L1 parameters, configured through RRC or indicated in DCI, of different CG PUSCHs or different SPS PUSCHs or the first resource; or
an L1 parameter, configured through RRC or indicated in DCI, of a specific CG PUSCH or a specific SPS PUSCH or the first resource; or
an L1 parameter, configured through the RRC or indicated in the DCI, of the first CG PUSCH or the first SPS PUSCH or the first resource, and an offset of another CG PUSCH or another SPS PUSCH or the first resource relative to the first CG PUSCH or the first SPS PUSCH or the first resource; or
an L1 parameter, configured through the RRC or indicated in the DCI, of a specific CG PUSCH or a specific SPS PUSCH or the first resource, and an offset of another CG PUSCH or another SPS PUSCH or the first resource relative to the specific CG PUSCH or the specific SPS PUSCH or the first resource.

In at least one embodiment, in a case that the configuration information includes the mapping relationship or the association relationship between a first LCH and the first resource, or the logical channel mapping limitation, at least one of the following is included:
the first LCH corresponds to an XR service;
the first resource is associated with the first LCH, or the first LCH is capable of being mapped to the first resource;
the first resource is associated with only the first LCH; or
the first LCH is associated with only the first resource.

In at least one embodiment, the processor 1102 is further configured to schedule, by using DCI, retransmission of a plurality of CG resources or SPS resources.

In at least one embodiment, the plurality of CG resources are a grant for retransmission scheduling of at least one of the plurality of CG PUSCHs configured in one CG periodicity.

The plurality of SPS resources are a grant for retransmission scheduling of at least one of the plurality of SPS PUSCHs configured in one SPS periodicity.

In at least one embodiment, the processor 1102 is further adapted to configure or schedule a first resource or a resource location that is not used by the terminal device for another terminal device; or
the processor 1102 is further adapted to: at a first resource or a resource location that is not used by the terminal device, schedule another UE to perform transmission, or allocate a transmission resource for another UE.

In at least one embodiment, at least one of the configuration information, the CG resource, or a service feature is used to perform at least one of configuring of the CG resource, determining of use of the CG resource, data transmission by using the CG resource, or reporting.

In at least one embodiment, at least one of the configuration information, the CG resource, or a service feature is used for determining use of the CG resource directly/automatically/based on a condition, or performing data transmission by using the CG resource directly/automatically/based on a condition.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the processes or functions described according to embodiments of this application are completely or partly generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired ((such as a coaxial cable, an optical fiber, and a digital subscriber line (DSL)) manner or a wireless (such as infrared, wireless, and microwave) manner. The computer-readable storage medium may be any usable medium that is storable by a computer, or a data storage device, such as a server or a data center, integrating one or more usable media. The available medium may be a magnetic medium (for example, a floppy disk, a hard disk, or a magnetic tape), an optical medium (for example, a DVD), a semiconductor medium ((for example, a solid state disk (SSD)), or the like.

In the specification, claims, and accompanying drawings of this application, the terms “first”, “second”, “third”, “fourth”, and so on (if there exists) are intended to distinguish between similar objects but do not necessarily indicate a specific order or sequence. It should be understood that the data termed in such a way are interchangeable in proper circumstances so that embodiments described herein can be implemented in other orders than the order illustrated or described herein. In addition, the terms “include” and “have” and any other variants thereof are intended to cover the non-exclusive inclusion. For example, a process, method, system, product, or device that includes a series of steps or units is not necessarily limited to those expressly listed steps or units, but may include other steps or units not expressly listed or inherent to such process, method, product, or device.

What is claimed is:

1. A method for transmitting an extended reality (XR) service, comprising:
determining, by a terminal device, use of a configured grant (CG) resource based on configuration information and a service feature, and reporting by the terminal device.

2. The method according to claim 1, wherein the determining, by a terminal device, use of a CG resource based on configuration information and a service feature, and reporting by the terminal device comprises:
determining, by the terminal device, a use status of the CG resource based on the configuration information and a service feature of the XR service, and reporting the use status of the CG resource by the terminal device.

3. The method according to claim 1, wherein the configuration information is CG configuration information sent by a network device.

4. A terminal device, comprising:
a memory storing executable program codes; and
a processor that is coupled to the memory, and a transceiver,
wherein the processor is configured to perform:
determining use of a configured grant (CG) resource based on configuration information and a service feature, and reporting.

5. The terminal device according to claim 4, wherein the determining use of a CG resource based on configuration information and a service feature, and reporting comprises:
determining a use status of the CG resource based on the configuration information and a service feature of an extended reality (XR) service, and reporting the use status of the CG resource.

6. The terminal device according to claim 4, wherein:
the configuration information is CG configuration information sent by a network device.

7. The terminal device according to claim 4, wherein the configuration information comprises at least one of following:
one CG resource;
that a type of the CG resource is CG Type1 or CG Type2;
a parameter corresponding to a first condition and a second condition, wherein the first condition and the second condition are used for using/activating/resuming or used for not using/deactivating/suspending;
an enabling or activation indication corresponding to the first condition and the second condition; or
an enabling or activation indication for the terminal device to perform, automatically or based on a condition, using/activating/resuming and/or not using/deactivating/suspending on the CG resource.

8. The terminal device according to claim 7, wherein:
each periodicity of the one CG resource comprises a plurality of CG physical uplink shared channels (PUSCHs);
the plurality of CG PUSCHs are consecutive in one periodicity; or
different hybrid automatic repeat request (HARQ) processes are used for the plurality of CG PUSCHs in one periodicity.

9. The terminal device according to claim 4, wherein the service feature comprises at least one of data packet information or data volume information.

10. The terminal device according to claim 9, wherein:
the data packet information comprises at least one of following: data-packet-size information, a data-packet-size change status, a data-packet-size change rule, a data-packet change periodicity, or a data-packet-size change start location/offset; or
the data volume information comprises at least one of following: data-volume-size information, a data-volume-size change status, a data-volume-size change rule, a data-volume change periodicity, and a data-volume change start location/offset.

11. The terminal device according to claim 7, wherein:
the processor is specifically configured to: perform using, activation, resuming, not using, deactivation, or suspending on the CG resource automatically or based on a condition.

12. The terminal device according to claim 11, wherein:
the transceiver is configured to: report information that the CG resource is not used or deactivated or suspended to the network device.

13. The terminal device according to claim 12, wherein:
the transceiver is specifically configured to report, by using a used or activated or resumed CG resource, the information that the CG resource is not used or deactivated or suspended to the network device; or
the transceiver is specifically configured to report, by using an uplink resource, the information that the CG resource is not used or deactivated or suspended to the network device; or
the transceiver is specifically configured to report, by using uplink signalling, the information that the CG resource is not used or deactivated or suspended to the network device.

14. The terminal device according to claim 12, wherein the information that the CG resource is not used or deactivated or suspended comprises:
a CG PUSCH that is not used or deactivated or suspended.

15. The terminal device according to claim 4, wherein:
the transceiver is further configured to report the service feature or the data packet information to the network device, wherein the service feature or the data packet information is used for the network device to indicate that the CG resource is not used, deactivated or suspended.

16. A network device, comprising:
a memory storing executable program codes; and
a processor coupled to the memory,
wherein the processor is configured to:
perform, based on a service feature, resource configuration or scheduling on a terminal device or a service to schedule a first resource, to obtain configuration information and/or a configured first resource, wherein the first resource comprises a configured grant (CG) resource and/or a semi-persistent scheduling (SPS) resource.

17. The network device according to claim 16, wherein the service feature comprises at least one of data packet information or data volume information.

18. The network device according to claim 17, wherein:
the data packet information comprises at least one of following: data-packet-size information, a data-packet-size change status, a data-packet-size change rule, a data-packet change periodicity, or a data-packet-size change start location/offset; or
the data volume information comprises at least one of following: data-volume-size information, a data-volume-size change status, a data-volume-size change rule, a data-volume change periodicity, or a data-volume change start location/offset.

19. The network device according to claim 16, wherein the first resource comprises the CG resource, and the configuration information comprises at least one of following:
one CG resource;
that a type of the CG resource is CG Type1 or CG Type2;
a parameter corresponding to a first condition and a second condition, wherein the first condition and the second condition are used for using/activating/resuming or used for not using/deactivating/suspending;
an enabling or activation indication corresponding to the first condition and the second condition; or
an enabling or activation indication for the terminal device to perform, automatically or based on a condition, using/activating/resuming and/or not using/deactivating/suspending on the first resource.

20. The network device according to claim 19, wherein:
each periodicity of the one first resource comprises a plurality of CG physical uplink shared channels (PUSCHs);
the plurality of CG PUSCHs are consecutive in one periodicity; or
different hybrid automatic repeat request (HARQ) processes are used for the plurality of CG PUSCHs in one periodicity.
